(19) United States
(12) Patent Application Publication
(10) Pub. No.: US 2025/0080208 A1
(43) Pub. Date: Mar. 6, 2025

(54) LOW LATENCY RELAY TRANSMISSIONS WITH SIMULTANEOUS TRANSMIT AND RECEIVE MULTI-LINK DEVICES

(71) Applicant: NEWRACOM, Inc., Irvine, CA (US)

(72) Inventors: Il-Gu LEE, Seoul (KR); Joonsoo LEE, Seoul (KR); Si-Chan NOH, Seoul (KR); Heejung YU, Daejeon (KR)

(73) Assignee: NEWRACOM, Inc., Irvine, CA (US)

(21) Appl. No.: 18/818,391

(22) Filed: Aug. 28, 2024

Related U.S. Application Data
(60) Provisional application No. 63/580,690, filed on Sep. 5, 2023.

(51) Int. Cl. H04B 7/185; H04L 1/24

(52) U.S. Cl. CPC H04B 7/18513; H04L 1/24

(57) ABSTRACT

An embodiment is method performed by a relay station (STA) that acts as a relay between a source STA and a destination STA. The method includes wirelessly receiving a physical layer protocol data unit (PPDU) from the source STA in a first channel, while receiving the PPDU from the source STA in the first channel, relaying the PPDU to the destination STA in a second channel that is different from the first channel, and responsive to detecting an error in receiving the PPDU from the source STA, ending the relaying of the PPDU to the destination STA early.

### CROSS-REFERENCE TO RELATED APPLICATION

This application claims the benefit of U.S. Provisional Application No. 63/580,690 filed Sep. 5, 2023, which is hereby incorporated by reference.

### TECHNICAL FIELD

The present disclosure generally relates to wireless communications, and more specifically, relates to low latency relay transmissions with simultaneous transmit and receive (STR) multi-link devices (MLDs).

### BACKGROUND

Institute of Electrical and Electronics Engineers (IEEE) 802.11 is a set of standards for implementing wireless local area network communication in various frequencies, including but not limited to the 2.4 gigahertz (GHz), 5 GHZ, 6 GHZ, and 60 GHz bands. These standards define the protocols that enable Wi-Fi devices to communicate with each other. The IEEE 802.11 family of standards has evolved over time to accommodate higher data rates, improved security, and better performance in different environments. Some of the most widely used standards include 802.11a, 802.11b, 802.11 g, 802.11n, 802.11ac, and 802.11ax (also known as “Wi-Fi 6”). These standards specify the modulation techniques, channel bandwidths, and other technical aspects that facilitate interoperability between devices from various manufacturers. IEEE 802.11 has played an important role in the widespread adoption of wireless networking in homes, offices, and public spaces, enabling users to connect their devices to the internet and each other without the need for wired connections.

IEEE 802.11be, also known as “Wi-Fi 7”, is the next generation of the IEEE 802.11 family of standards for wireless local area networks. Currently under development, 802.11be aims to significantly improve upon the capabilities of its predecessor, 802.11ax/Wi-Fi 6, by offering even higher data rates, lower latency, and increased reliability. The standard is expected to leverage advanced technologies such as multi-link operation (MLO), which allows devices to simultaneously use multiple frequency bands and channels for enhanced performance and reliability. Additionally, 802.11be will introduce 4096-QAM (Quadrature Amplitude Modulation), enabling higher data rates by encoding more bits per symbol. The standard will also feature improved medium access control (MAC) efficiency, enhanced power saving capabilities, and better support for high-density environments. With these advancements, 802.11be is expected to deliver theoretical maximum data rates of up to 46 gigabits per second (Gbps), making it suitable for bandwidth-intensive applications such as virtual and augmented reality, 8K video streaming, and high-performance gaming. The IEEE 802.11be standard is projected to be finalized by the end of 2024, paving the way for the next generation of Wi-Fi devices and networks.

Relay operations are expected to be used in next generation wireless networks (e.g., wireless networks that are to implement the beyond IEEE 802.11be or IEEE 802.11bn wireless networking standard) to expand communication coverage area and improve network efficiency. With relayed operations, a relay station (STA) that is communicatively situated between a source STA and a destination STA may relay transmissions from the source STA to the destination STA (and vice versa). Relayed transmissions generally have higher latency (compared to non-relayed transmissions) due to the transmissions having to go through the relay STA. The latency can increase even more when transmission or reception errors occur at the relay STA, due to inefficiencies of the retransmission process.

### BRIEF DESCRIPTION OF THE DRAWINGS

The disclosure will be more fully understood from the detailed description provided below and the accompanying drawings that depict various embodiments of the disclosure. However, these drawings should not be interpreted as limiting the disclosure to the specific embodiments shown; they are provided for explanation and understanding only.

FIG. 1 illustrates an example of a wireless local area network (WLAN) with a basic service set (BSS) that includes multiple wireless devices, in accordance with some embodiments of the present disclosure.

FIG. 2 is a schematic diagram of a wireless device, in accordance with some embodiments of the present disclosure.

FIG. 3A illustrates components of a wireless device configured to transmit data, in accordance with some embodiments of the present disclosure.

FIG. 3B illustrates components of a wireless device configured to receive data, in accordance with some embodiments of the present disclosure.

FIG. 4 illustrates interframe space (IFS) relationships, in accordance with some embodiments of the present disclosure.

FIG. 5 illustrates a Carrier Sense Multiple Access with Collision Avoidance (CSMA/CA)-based frame transmission procedure, in accordance with some embodiments of the present disclosure.

FIG. 6 illustrates maximum physical layer (PHY) rates for Institute of Electrical and Electronics Engineers (IEEE) 802.11 standards, in accordance with some embodiments of the present disclosure.

FIG. 7 provides a detailed description of fields in Extremely High Throughput (EHT) Physical Protocol Data Unit (PPDU) frames, including their purposes and characteristics, in accordance with some embodiments of the present disclosure.

FIG. 8 illustrates an example of multi-user (MU) transmission in Orthogonal Frequency-Division Multiple Access (OFDMA), in accordance with some embodiments of the present disclosure.

FIG. 9 illustrates an example of an access point sending a trigger frame to multiple associated stations and receiving Uplink Orthogonal Frequency-Division Multiple Access Trigger-Based Physical Protocol Data Units (UL OFDMA TB PPDUs) in response, in accordance with some embodiments of the present disclosure.

FIG. 10 is a diagram showing a network configuration in which relay operations may be used for station-to-station communications, according to some embodiments.

FIG. 11 is a diagram showing a network configuration in which relay operations may be used for multiple AP-to-station communications, according to some embodiments.

FIG. 12 is a diagram showing relay operations with a non-STR MLD relay STA, according to some embodiments.

FIG. 13 is a diagram showing relay operations with a STR MLD relay STA, according to some embodiments.

FIG. 14 is a diagram showing an example of inefficient retransmission when an error situation occurs, according to some embodiments.

FIG. 15 is a diagram showing a first approach for determining that an error occurred in the relay STA receiving the PPDU, according to some embodiments.

FIG. 16 is a diagram showing a second approach for determining that an error occurred in the relay STA receiving the PPDU, according to some embodiments.

FIG. 17 is a diagram showing a third approach for determining that an error occurred in the relay STA receiving the PPDU, according to some embodiments.

FIG. 18 is a diagram showing a fourth approach for determining that an error occurred in the relay STA receiving the PPDU, according to some embodiments.

FIG. 19 is a diagram showing an example of a relay STA ending transmission of a relay PPDU early based on detecting a signal field decoding error, according to some embodiments.

FIG. 20 is a diagram showing an example of a source STA ending transmission of a PPDU early based on detecting that a relay STA ended transmission of a relay PPDU early, according to some embodiments.

FIG. 21 is a diagram showing an example format of an aggregated PPDU, according to some embodiments.

FIG. 22 is a diagram showing an example of a relay STA ending transmission of a relay A-PPDU early based on detecting a sub-PPDU decoding error, according to some embodiments.

FIG. 23 is a flowchart of a method for performing relay operations, according to some embodiments.

FIG. 24 is a flowchart of another method for retransmitting a PPDU with low latency, according to some embodiments.

### DETAILED DESCRIPTION

The present disclosure generally relates to wireless communications, and more specifically, relates to low latency relay transmissions with simultaneous transmit and receive (STR) multi-link devices (MLDs).

As mentioned above, relayed transmissions generally have higher latency (compared to non-relayed transmissions) due to the transmissions having to go through the relay STA. The latency can increase even more when transmission or reception errors occur at the relay STA, due to inefficiencies of the retransmission process (e.g., where the source STA has to wait for an ACK timeout to occur before realizing that an error situation has occurred and that the data has to be retransmitted).

A STR MLD may simultaneously transmit and receive data in different channels in the same and/or different frequency band. If the relay STA is a STR MLD, the relay STA may receive a PPDU from the source STA in a first channel and relay the PPDU to the destination STA in a second channel while receiving the PPDU from the source STA, thereby reducing relay transmission latency. Also, the relay STA may transmit an acknowledgement (ACK) frame that acknowledges the frame included in the PPDU to the source STA in the first channel while relaying the PPDU to the destination STA in the second channel, thereby further reducing relay transmission latency.

The present disclosure describes ways to reduce the latency of relay transmissions with STR-MLDs. In particular, the present disclosure describes embodiments that allow the source STA to quickly detect when an error situation has occurred at the relay STA and retransmit the data without having to wait for an ACK timeout to occur.

According to some embodiments, a source STA may transmit a PPDU intended for a destination STA in a first channel. A relay STA may be communicatively situated between the source STA and the destination STA act as a relay between the source STA and the destination STA. The relay STA may be a STR MLD that can simultaneously transmit data in one channel and receive data in another channel. The relay STA may relay the PPDU transmitted by the source STA to the destination STA in a second channel that is different from the first channel. If the source STA determines that an error occurred in the relay STA receiving the PPDU, the source STA may retransmit the PPDU intended for the destination STA in the first channel before an ACK timeout (the ACK timeout for the initial PPDU transmitted by the source STA) occurs.

Four different approaches for the source STA to determine that an error occurred in the relay STA receiving the PPDU are described herein.

### Approach #1: Detect Relay Negative Acknowledgement (NACK) Frame

According to the first approach, if the relay STA detects an error in receiving the PPDU from the source STA, the relay STA may end the relaying of the PPDU to the destination STA early and transmit a NACK frame to the source STA in the first channel. The source STA may determine that an error occurred in the relay STA receiving the PPDU based on receiving the NACK frame from the relay STA in the first channel. Responsive to determining that an error occurred in the relay STA receiving the PPDU, the source STA may retransmit the PPDU intended for the destination STA in the first channel before an ACK timeout occurs. The first approach may be considered to be an explicit error detection approach (since the relay STA provides explicit notification to the source STA regarding the error situation).

Approach #2. Detect that Relaying Ended Early

According to the second approach, if the relay STA detects an error in receiving the PPDU from the source STA, the relay STA may end the relaying of the PPDU to the destination STA early. The source STA may determine that an error occurred in the relay STA receiving the PPDU based on detecting that the relay STA ended relaying of the PPDU early. Responsive to determining that an error occurred in the relay STA receiving the PPDU, the source STA may retransmit the PPDU intended for the destination STA in the first channel before an ACK timcout occurs. The second approach may be considered to be an implicit error detection approach (since the relay STA does not provide an explicit notification regarding the error situation to the source STA but the source STA infers the error situation based on detecting that the relaying of the PPDU ended early).

### Approach #3: Detect Error Indicator

According to the third approach, if the relay STA detects an error in receiving the PPDU from the source STA, the relay STA may end the relaying of the PPDU to the destination STA early and transmit an error indicator in the second channel. The source STA may determine that an error occurred in the relay STA receiving the PPDU based on receiving the error indicator in the second channel. Responsive to determining that an error occurred in the relay STA receiving the PPDU, the source STA may retransmit the PPDU intended for the destination STA in the first channel before an ACK timeout occurs. The third approach may be considered to be an explicit error detection approach (since the relay STA provides explicit notification to the source STA regarding the error situation).

### Approach #4. Integrity Check

According to the fourth approach, the source STA may determine that an error occurred in the relay STA receiving the PPDU based on detecting that the relay PPDU transmitted by the relay STA in the second channel does not match the PPDU transmitted by the source STA in the first channel. Responsive to determining that an error occurred in the relay STA receiving the PPDU, the source STA may retransmit the PPDU intended for the destination STA in the first channel before an ACK timeout occurs. The fourth approach may be considered to be an implicit error detection approach (since the relay STA does not provide an explicit notification regarding the error situation to the source STA but the source STA infers the error situation based on detecting that the relay PPDU does not match the original PPDU).

Also disclosed herein is an aggregated PPDU (A-PPDU) format that can be used to efficiently detect signal field errors and/or individual sub-PPDU errors when using a decode-and-forward relay transmission mechanism. In an embodiment, the A-PPDU includes a plurality of sub-PPDUs and a plurality of cyclic redundancy check (CRC) fields each corresponding to one of the plurality of sub-PPDUs. A relay STA that received the A-PPDU may perform a CRC of a sub-PPDU using a CRC value included in the corresponding CRC field to determine whether the sub-PPDU was correctly received and decoded. The relay STA may end relaying of the A-PPDU early if it determines that a sub-PPDU included in the A-PPDU was not correctly received and decoded.

For purposes of illustration, various embodiments are described herein in the context of wireless networks that are based on IEEE 802.11 standards and using terminology and concepts thereof. Those skilled in the art will appreciate that the embodiments disclosed herein can be modified/adapted for use in other types of wireless networks.

In the following detailed description, only certain embodiments of the present invention have been shown and described, simply by way of illustration. As those skilled in the art would realize, the described embodiments may be modified in different ways, all without departing from the spirit or scope of the present invention. Accordingly, the drawings and description are to be regarded as illustrative in nature and not restrictive. Like reference numerals designate like elements throughout the specification.

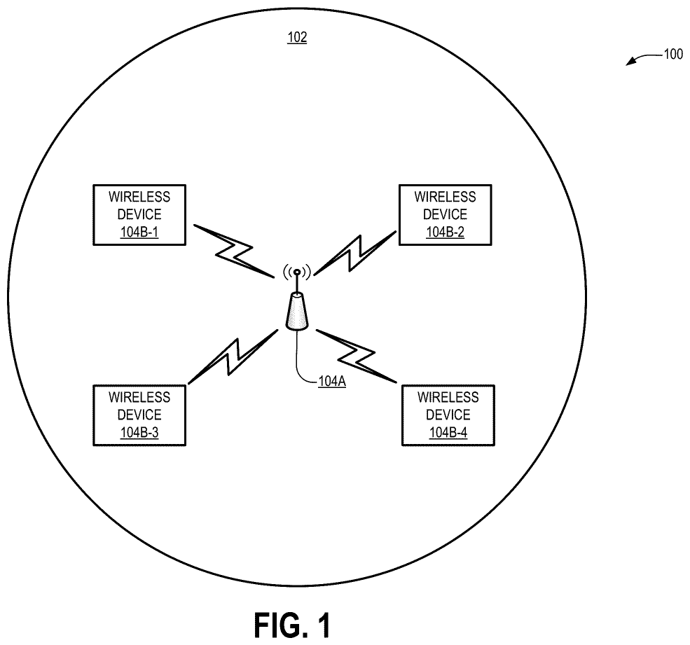

FIG. 1 shows a wireless local area network (WLAN) 100 with a basic service set (BSS) 102 that includes a plurality of wireless devices 104 (sometimes referred to as WLAN devices 104). Each of the wireless devices 104 may include a medium access control (MAC) layer and a physical (PHY) layer according to an IEEE (Institute of Electrical and Electronics Engineers) standard 802.11, including one or more of the amendments (e.g., 802.11a/b/g/n/p/ac/ax/bd/be). In one embodiment, the MAC layer of a wireless device 104 may initiate transmission of a frame to another wireless device 104 by passing a PHY-TXSTART.request (TXVECTOR) to the PHY layer. The TXVECTOR provides parameters for generating and/or transmitting a corresponding frame. Similarly, a PHY layer of a receiving wireless device may generate an RXVECTOR, which includes parameters of a received frame and is passed to a MAC layer for processing.

The plurality of wireless devices 104 may include a wireless device 104A that is an access point (sometimes referred to as an AP station or AP STA) and the other wireless devices 104B1-104B4 that are non-AP stations (sometimes referred to as non-AP STAs). Alternatively, all the plurality of wireless devices 104 may be non-AP STAs in an ad-hoc networking environment. In general, the AP STA (e.g., wireless device 104A) and the non-AP STAs (e.g., wireless devices 104B1-104B4) may be collectively referred to as STAs. However, for case of description, only the non-AP STAs may be referred to as STAs unless the context indicates otherwise. Although shown with four non-AP STAs (e.g., the wireless devices 104B1-104B4), the WLAN 100 may include any number of non-AP STAs (e.g., one or more wireless devices 104B).

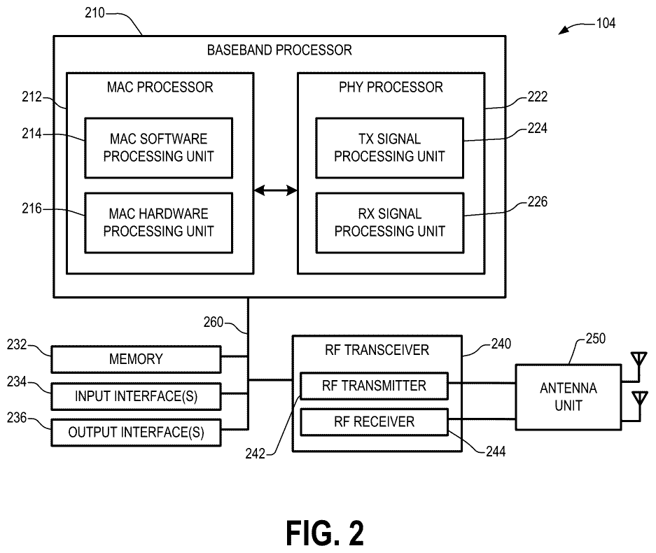

FIG. 2 illustrates a schematic block diagram of a wireless device 104, according to an embodiment. The wireless device 104 may be the wireless device 104A (i.e., the AP of the WLAN 100) or any of the wireless devices 104B1-104B4 in FIG. 1. The wireless device 104 includes a baseband processor 210, a radio frequency (RF) transceiver 240, an antenna unit 250, a storage device (e.g., memory device) 232, one or more input interfaces 234, and one or more output interfaces 236. The baseband processor 210, the storage device 232, the input interfaces 234, the output interfaces 236, and the RF transceiver 240 may communicate with each other via a bus 260.

The baseband processor 210 performs baseband signal processing and includes a MAC processor 212 and a PHY processor 222. The baseband processor 210 may utilize the memory 232, which may include a non-transitory computer/machine readable medium having software (e.g., computer/machine programing instructions) and data stored therein.

In an embodiment, the MAC processor 212 includes a MAC software processing unit 214 and a MAC hardware processing unit 216. The MAC software processing unit 214 may implement a first plurality of functions of the MAC layer by executing MAC software, which may be included in the software stored in the storage device 232. The MAC hardware processing unit 216 may implement a second plurality of functions of the MAC layer in special-purpose hardware. However, the MAC processor 212 is not limited thereto. For example, the MAC processor 212 may be configured to perform the first and second plurality of functions entirely in software or entirely in hardware according to an implementation.

The PHY processor 222 includes a transmitting (TX) signal processing unit (SPU) 224 and a receiving (RX) SPU 226. The PHY processor 222 implements a plurality of functions of the PHY layer. These functions may be performed in software, hardware, or a combination thereof according to an implementation.

Functions performed by the transmitting SPU 224 may include one or more of Forward Error Correction (FEC) encoding, stream parsing into one or more spatial streams, diversity encoding of the spatial streams into a plurality of space-time streams, spatial mapping of the space-time streams to transmit chains, inverse Fourier Transform (iFT) computation, Cyclic Prefix (CP) insertion to create a Guard Interval (GI), and the like. Functions performed by the receiving SPU 226 may include inverses of the functions performed by the transmitting SPU 224, such as GI removal, Fourier Transform computation, and the like.

The RF transceiver 240 includes an RF transmitter 242 and an RF receiver 244. The RF transceiver 240 is configured to transmit first information received from the baseband processor 210 to the WLAN 100 (e.g., to another WLAN device 104 of the WLAN 100) and provide second information received from the WLAN 100 (e.g., from another WLAN device 104 of the WLAN 100) to the baseband processor 210.

The antenna unit 250 includes one or more antennas. When Multiple-Input Multiple-Output (MIMO) or Multi-User MIMO (MU-MIMO) is used, the antenna unit 250 may include a plurality of antennas. In an embodiment, the antennas in the antenna unit 250 may operate as a beam-formed antenna array. In an embodiment, the antennas in the antenna unit 250 may be directional antennas, which may be fixed or steerable.

The input interfaces 234 receive information from a user, and the output interfaces 236 output information to the user. The input interfaces 234 may include one or more of a keyboard, keypad, mouse, touchscreen, microphone, and the like. The output interfaces 236 may include one or more of a display device, touch screen, speaker, and the like.

As described herein, many functions of the WLAN device 104 may be implemented in cither hardware or software. Which functions are implemented in software and which functions are implemented in hardware will vary according to constraints imposed on a design. The constraints may include one or more of design cost, manufacturing cost, time to market, power consumption, available semiconductor technology, etc.

As described herein, a wide variety of electronic devices, circuits, firmware, software, and combinations thereof may be used to implement the functions of the components of the WLAN device 104. Furthermore, the WLAN device 104 may include other components, such as application processors, storage interfaces, clock generator circuits, power supply circuits, and the like, which have been omitted in the interest of brevity.

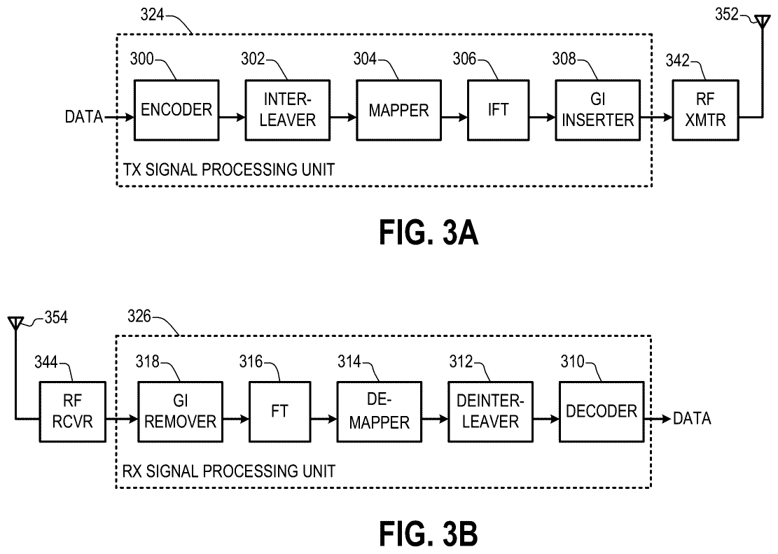

FIG. 3A illustrates components of a WLAN device 104 configured to transmit data according to an embodiment, including a transmitting (Tx) SPU (TxSP) 324, an RF transmitter 342, and an antenna 352. In an embodiment, the TxSP 324, the RF transmitter 342, and the antenna 352 correspond to the transmitting SPU 224, the RF transmitter 242, and an antenna of the antenna unit 250 of FIG. 2, respectively.

The TxSP 324 includes an encoder 300, an interleaver 302, a mapper 304, an inverse Fourier transformer (IFT) 306, and a guard interval (GI) inserter 308.

The encoder 300 receives and encodes input data. In an embodiment, the encoder 300 includes a forward error correction (FEC) encoder. The FEC encoder may include a binary convolution code (BCC) encoder followed by a puncturing device. The FEC encoder may include a low-density parity-check (LDPC) encoder.

The TxSP 324 may further include a scrambler for scrambling the input data before the encoding is performed by the encoder 300 to reduce the probability of long sequences of Os or 1 s. When the encoder 300 performs the BCC encoding, the TxSP 324 may further include an encoder parser for demultiplexing the scrambled bits among a plurality of BCC encoders. If LDPC encoding is used in the encoder, the TxSP 324 may not use the encoder parser.

The interleaver 302 interleaves the bits of each stream output from the encoder 300 to change an order of bits therein. The interleaver 302 may apply the interleaving only when the encoder 300 performs BCC encoding and otherwise may output the stream output from the encoder 300 without changing the order of the bits therein.

The mapper 304 maps the sequence of bits output from the interleaver 302 to constellation points. If the encoder 300 performed LDPC encoding, the mapper 304 may also perform LDPC tone mapping in addition to constellation mapping.

When the TxSP 324 performs a MIMO or MU-MIMO transmission, the TxSP 324 may include a plurality of interleavers 302 and a plurality of mappers 304 according to a number of spatial streams (NSS) of the transmission. The TxSP 324 may further include a stream parser for dividing the output of the encoder 300 into blocks and may respectively send the blocks to different interleavers 302 or mappers 304. The TxSP 324 may further include a space-time block code (STBC) encoder for spreading the constellation points from the spatial streams into a number of space-time streams (NSTS) and a spatial mapper for mapping the space-time streams to transmit chains. The spatial mapper may use direct mapping, spatial expansion, or beamforming.

The IFT 306 converts a block of the constellation points output from the mapper 304 (or, when MIMO or MU-MIMO is performed, the spatial mapper) to a time domain block (i.e., a symbol) by using an inverse discrete Fourier transform (IDFT) or an inverse fast Fourier transform (IFFT). If the STBC encoder and the spatial mapper are used, the IFT 306 may be provided for each transmit chain.

When the TxSP 324 performs a MIMO or MU-MIMO transmission, the TxSP 324 may insert cyclic shift diversities (CSDs) to prevent unintentional beamforming. The TxSP 324 may perform the insertion of the CSD before or after the IFT 306. The CSD may be specified per transmit chain or may be specified per space-time stream. Alternatively, the CSD may be applied as a part of the spatial mapper.

When the TxSP 324 performs a MIMO or MU-MIMO transmission, some blocks before the spatial mapper may be provided for each user.

The GI inserter 308 prepends a GI to each symbol produced by the IFT 306. Each GI may include a Cyclic Prefix (CP) corresponding to a repeated portion of the end of the symbol that the GI precedes. The TxSP 324 may optionally perform windowing to smooth edges of each symbol after inserting the GI.

The RF transmitter 342 converts the symbols into an RF signal and transmits the RF signal via the antenna 352. When the TxSP 324 performs a MIMO or MU-MIMO transmission, the GI inserter 308 and the RF transmitter 342 may be provided for each transmit chain.

FIG. 3B illustrates components of a WLAN device 104 configured to receive data according to an embodiment, including a Receiver (Rx) SPU (RxSP) 326, an RF receiver 344, and an antenna 354. In an embodiment, the RxSP 326, RF receiver 344, and antenna 354 may correspond to the receiving SPU 226, the RF receiver 244, and an antenna of the antenna unit 250 of FIG. 2, respectively.

The RxSP 326 includes a GI remover 318, a Fourier transformer (FT) 316, a demapper 314, a deinterleaver 312, and a decoder 310.

The RF receiver 344 receives an RF signal via the antenna 354 and converts the RF signal into symbols. The GI remover 318 removes the GI from each of the symbols. When the received transmission is a MIMO or MU-MIMO transmission, the RF receiver 344 and the GI remover 318 may be provided for each receive chain.

The FT 316 converts each symbol (that is, each time domain block) into a frequency domain block of constellation points by using a discrete Fourier transform (DFT) or a fast Fourier transform (FFT). The FT 316 may be provided for each receive chain.

When the received transmission is the MIMO or MU-MIMO transmission, the RxSP 326 may include a spatial demapper for converting the respective outputs of the FTs 316 of the receiver chains to constellation points of a plurality of space-time streams, and an STBC decoder for despreading the constellation points from the space-time streams into one or more spatial streams.

The demapper 314 demaps the constellation points output from the FT 316 or the STBC decoder to bit streams. If the received transmission was encoded using LDPC encoding, the demapper 314 may further perform LDPC tone demapping before performing the constellation demapping.

The deinterleaver 312 deinterleaves the bits of each stream output from the demapper 314. The deinterleaver 312 may perform the deinterleaving only when the received transmission was encoded using BCC encoding, and otherwise may output the stream output by the demapper 314 without performing deinterleaving.

When the received transmission is the MIMO or MU-MIMO transmission, the RxSP 326 may use a plurality of demappers 314 and a plurality of deinterleavers 312 corresponding to the number of spatial streams of the transmission. In this case, the RxSP 326 may further include a stream deparser for combining the streams output from the deinterleavers 312.

The decoder 310 decodes the streams output from the deinterleaver 312 or the stream deparser. In an embodiment, the decoder 310 includes an FEC decoder. The FEC decoder may include a BCC decoder or an LDPC decoder.

The RxSP 326 may further include a descrambler for descrambling the decoded data. When the decoder 310 performs BCC decoding, the RxSP 326 may further include an encoder deparser for multiplexing the data decoded by a plurality of BCC decoders. When the decoder 310 performs the LDPC decoding, the RxSP 326 may not use the encoder deparser.

Before making a transmission, wireless devices such as wireless device 104 will assess the availability of the wireless medium using Clear Channel Assessment (CCA). If the medium is occupied, CCA may determine that it is busy, while if the medium is available, CCA determines that it is idle.

The PHY entity for IEEE 802.11 is based on Orthogonal Frequency Division Multiplexing (OFDM) or Orthogonal Frequency Division Multiple Access (OFDMA). In either OFDM or OFDMA Physical (PHY) layers, a STA (e.g., a wireless device 104) is capable of transmitting and receiving Physical Layer (PHY) Protocol Data Units (PPDUs) (also referred to as PLCP (Physical Layer Convergence Procedure) Protocol Data Units) that are compliant with the mandatory PHY specifications. A PHY specification defines a set of Modulation and Coding Schemes (MCS) and a maximum number of spatial streams. Some PHY entities define downlink (DL) and uplink (UL) Multi-User (MU) transmissions having a maximum number of space-time streams (STS) per user and employing up to a predetermined total number of STSs. A PHY entity may provide support for 10 Megahertz (MHz), 20 MHz, 40 MHz, 80 MHz, 160 MHz, 240 MHz, and 320 MHz contiguous channel widths and support for an 80+80, 80+160 MHz, and 160+160 MHz non-contiguous channel width. Each channel includes a plurality of subcarriers, which may also be referred to as tones. A PHY entity may define signaling fields denoted as Legacy Signal (L-SIG), Signal A (SIG-A), and Signal B (SIG-B), and the like within a PPDU by which some necessary information about PHY Service Data Unit (PSDU) attributes are communicated. The descriptions below, for sake of completeness and brevity, refer to OFDM-based 802.11 technology. Unless otherwise indicated, a station refers to a non-AP STA.

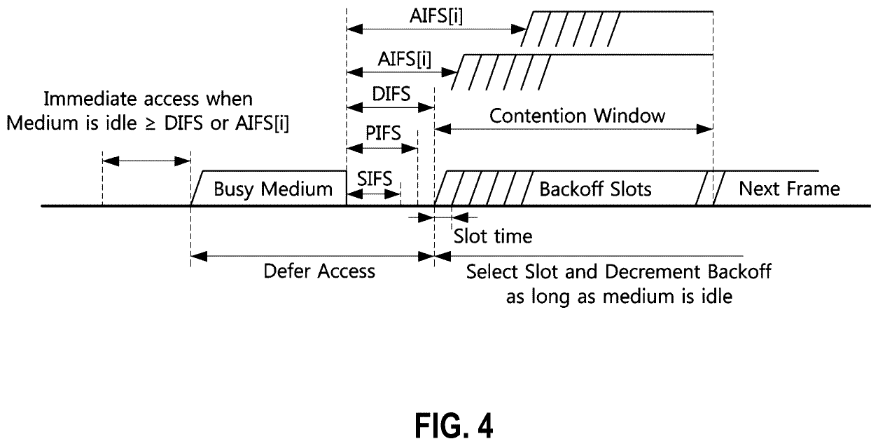

FIG. 4 illustrates Inter-Frame Space (IFS) relationships. In particular, FIG. 4 illustrates a Short IFS (SIFS), a Point Coordination Function (PCF) IFS (PIFS), a Distributed Coordination Function (DCF) IFS (DIFS), and an Arbitration IFSs corresponding to an Access Category (AC) ‘i’ (AIFS [i]). FIG. 4 also illustrates a slot time and a data frame is used for transmission of data forwarded to a higher layer. As shown, a WLAN device 104 transmits the data frame after performing backoff if a DIFS has elapsed during which the medium has been idle.

A management frame may be used for exchanging management information, which is not forwarded to the higher layer. Subtype frames of the management frame include a beacon frame, an association request/response frame, a probe request/response frame, and an authentication request/response frame.

A control frame may be used for controlling access to the medium. Subtype frames of the control frame include a request to send (RTS) frame, a clear to send (CTS) frame, and an acknowledgement (ACK) frame.

When the control frame is not a response frame of another frame, the WLAN device 104 transmits the control frame after performing backoff if a DIFS has elapsed during which the medium has been idle. When the control frame is the response frame of another frame, the WLAN device 104 transmits the control frame after a SIFS has elapsed without performing backoff or checking whether the medium is idle.

A WLAN device 104 that supports Quality of Service (QOS) functionality (that is, a QOS STA) may transmit the frame after performing backoff if an AIFS for an associated access category (AC) (i.e., AIFS [AC]) has elapsed. When transmitted by the QOS STA, any of the data frame, the management frame, and the control frame, which is not the response frame, may use the AIFS [AC] of the AC of the transmitted frame.

A WLAN device 104 may perform a backoff procedure when the WLAN device 104 that is ready to transfer a frame finds the medium busy. The backoff procedure includes determining a random backoff time composed of N backoff slots, where each backoff slot has a duration equal to a slot time and N being an integer number greater than or equal to zero. The backoff time may be determined according to a length of a Contention Window (CW). In an embodiment, the backoff time may be determined according to an AC of the frame. All backoff slots occur following a DIFS or Extended IFS (EIFS) period during which the medium is determined to be idle for the duration of the period.

When the WLAN device 104 detects no medium activity for the duration of a particular backoff slot, the backoff procedure shall decrement the backoff time by the slot time. When the WLAN device 104 determines that the medium is busy during a backoff slot, the backoff procedure is suspended until the medium is again determined to be idle for the duration of a DIFS or EIFS period. The WLAN device 104 may perform transmission or retransmission of the frame when the backoff timer reaches zero.

The backoff procedure operates so that when multiple WLAN devices 104 are deferring and execute the backoff procedure, each WLAN device 104 may select a backoff time using a random function and the WLAN device 104 that selects the smallest backoff time may win the contention, reducing the probability of a collision.

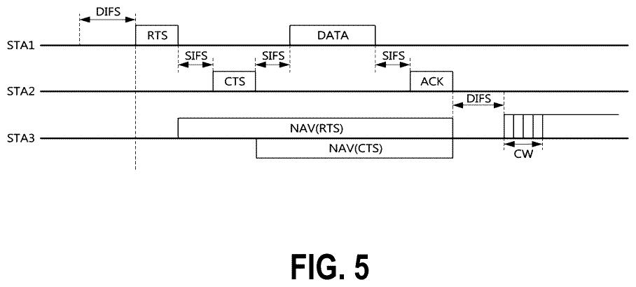

FIG. 5 illustrates a Carrier Sense Multiple Access/Collision Avoidance (CSMA/CA) based frame transmission procedure for avoiding collision between frames in a channel according to an embodiment. FIG. 5 shows a first station STA1 transmitting data, a second station STA2 receiving the data, and a third station STA3 that may be located in an area where a frame transmitted from the STA1 can be received, a frame transmitted from the second station STA2 can be received, or both can be received. The stations STA1, STA2, and STA3 may be WLAN devices 104 of FIG. 1.

The station STA1 may determine whether the channel is busy by carrier sensing. The station STA1 may determine channel occupation/status based on an energy level in the channel or an autocorrelation of signals in the channel, or may determine the channel occupation by using a network allocation vector (NAV) timer.

After determining that the channel is not used by other devices (that is, that the channel is IDLE) during a DIFS (and performing backoff if required), the station STA1 may transmit a Request-To-Send (RTS) frame to the station STA2. Upon receiving the RTS frame, after a SIFS the station STA2 may transmit a Clear-To-Send (CTS) frame as a response to the RTS frame. If Dual-CTS is enabled and the station STA2 is an AP, the AP may send two CTS frames in response to the RTS frame (e.g., a first CTS frame in a non-High Throughput format and a second CTS frame in the HT format).

When the station STA3 receives the RTS frame, it may set a NAV timer of the station STA3 for a transmission duration of subsequently transmitted frames (for example, a duration of SIFS+CTS frame duration+SIFS+data frame duration+SIFS+ACK frame duration) using duration information included in the RTS frame. When the station STA3 receives the CTS frame, it may set the NAV timer of the station STA3 for a transmission duration of subsequently transmitted frames using duration information included in the CTS frame. Upon receiving a new frame before the NAV timer expires, the station STA3 may update the NAV timer of the station STA3 by using duration information included in the new frame. The station STA3 does not attempt to access the channel until the NAV timer expires.

When the station STA1 receives the CTS frame from the station STA2, it may transmit a data frame to the station STA2 after a SIFS period elapses from a time when the CTS frame has been completely received. Upon successfully receiving the data frame, the station STA2 may transmit an ACK frame as a response to the data frame after a SIFS period elapses.

When the NAV timer expires, the third station STA3 may determine whether the channel is busy using the carrier sensing. Upon determining that the channel is not used by other devices during a DIFS period after the NAV timer has expired, the station STA3 may attempt to access the channel after a contention window elapses according to a backoff process.

When Dual-CTS is enabled, a station that has obtained a transmission opportunity (TXOP) and that has no data to transmit may transmit a CF-End frame to cut short the TXOP. An AP receiving a CF-End frame having a Basic Service Set Identifier (BSSID) of the AP as a destination address may respond by transmitting two more CF-End frames: a first CF-End frame using Space Time Block Coding (STBC) and a second CF-End frame using non-STBC. A station receiving a CF-End frame resets its NAV timer to 0 at the end of the PPDU containing the CF-End frame. FIG. 5 shows the station STA2 transmitting an ACK frame to acknowledge the successful reception of a frame by the recipient.

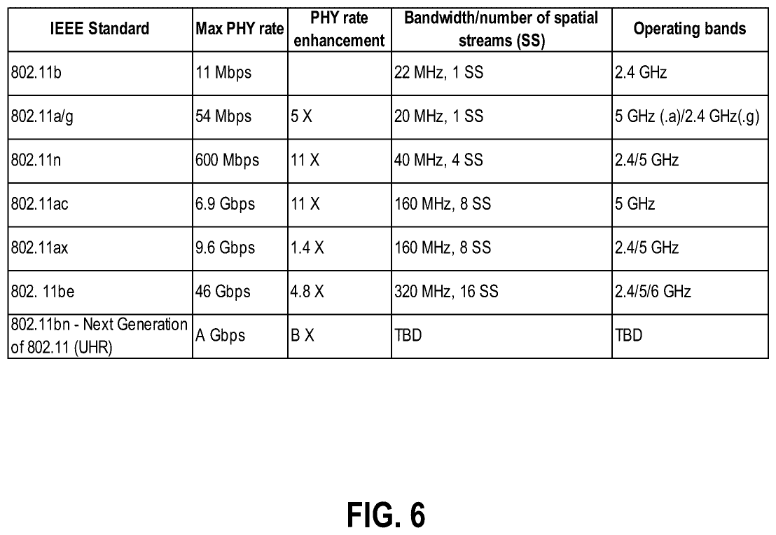

The IEEE 802.11bn (Ultra High Reliability, UHR) working group has been established to address the growing demand for higher peak throughput and reliability in Wi-Fi. As shown in FIG. 6, the peak PHY rate has significantly increased from IEEE 802.11b to IEEE 802.11be (Wi-Fi 7), with the latter focusing on further improving peak throughput. The UHR study group aims to enhance the tail of the latency distribution and jitter to support applications that require low latency, such as video-over-WLAN, gaming, AR, and VR. It is noted that various characteristics of UHR (e.g., max PHY rate, PHY rate enhancement, bandwidth/number of spatial streams, and operating bands) are still to be determined.

The focus of IEEE 802.11be is primarily on WLAN indoor and outdoor operation with stationary and pedestrian speeds in the 2.4, 5, and 6 GHz frequency bands. In addition to peak PHY rate, different candidate features are under discussion. These candidate features include (1) a 320 MHz bandwidth and a more efficient utilization of a non-contiguous spectrum, (2) multi-band/multi-channel aggregation and operation, (3) 16 spatial streams and Multiple Input Multiple Output (MIMO) protocol enhancements, (4) multi-Access Point (AP) Coordination (e.g., coordinated and joint transmission), (5) an enhanced link adaptation and retransmission protocol (e.g., Hybrid Automatic Repeat Request (HARQ)), and (6) adaptation to regulatory rules specific to a 6 GHz spectrum.

The focus of IEEE 802.11bn (UHR) is still under discussion, with candidate features including MLO enhancements (e.g., in terms of increased throughput/reliability and decreased latency), latency and reliability improvements (e.g., multi-AP coordination to support low latency traffic), bandwidth expansion (e.g., to 240, 480, 640 MHZ), aggregated PPDU (A-PPDU), enhanced multi-link single-radio (cMLSR) extensions to AP, roaming improvements, and power-saving schemes for prolonging battery life.

Some features, such as increasing the bandwidth and the number of spatial streams, are solutions that have been proven to be effective in previous projects focused on increasing link throughput and on which feasibility demonstration is achievable.

With respect to operational bands (e.g., 2.4/5/6 GHZ) for IEEE 802.11be, more than 1 GHz of additional unlicensed spectrum is likely to be available because the 6 GHz band (5.925-7.125 GHZ) is being considered for unlicensed use. This would allow APs and STAs to become tri-band devices. Larger than 160 MHz data transmissions (e.g., 320 MHz or 640 MHZ) could be considered to increase the maximum PHY rate. For example, 320 MHZ or 160+160 MHz data could be transmitted in the 6 GHz band. For example, 160+160 MHz data could be transmitted across the 5 and 6 GHz bands.

In the process of wireless communication, a transmitting station (STA) creates a Physical Layer Protocol Data Unit (PPDU) frame and sends it to a receiving STA. The receiving STA then receives, detects, and processes the PPDU.

The Extremely High Throughput (EHT) PPDU frame encompasses several components. It includes a legacy part, which comprises fields such as the Legacy Short Training Field (L-STF), Legacy Long Training Field (L-LTF), Legacy Signal Field (L-SIG), and Repeated Legacy Signal Field (RL-SIG). These fields are used to maintain compatibility with older Wi-Fi standards.

In addition to the legacy part, the EHT PPDU frame also contains the Universal Signal Field (U-SIG), EHT Signal Field (EHT-SIG), EHT Short Training Field (EHT-STF), and EHT Long Training Field (EHT-LTF). These fields are specific to the EHT standard and are used for various purposes, such as signaling, synchronization, and channel estimation.

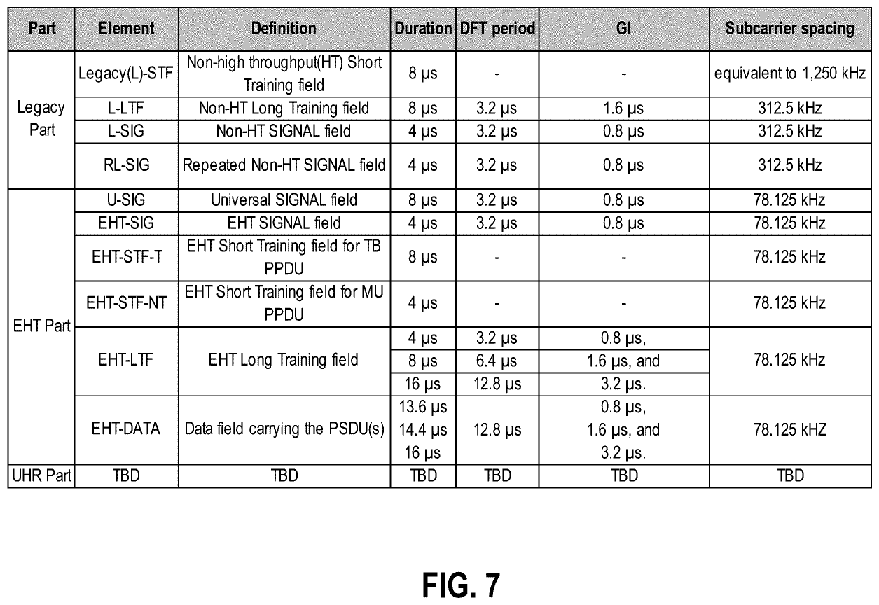

FIG. 7 provides a more detailed description of each field in the EHT PPDU frame, including their purposes and characteristics.

Regarding the Ultra High Reliability (UHR) PPDU, its frame structure is currently undefined and will be determined through further discussions within the relevant working group or study group. This indicates that the specifics of the UHR PPDU are still under development and will be finalized based on the outcomes of future deliberations.

The distributed nature of channel access networks, such as IEEE 802.11 WLANs, makes the carrier sense mechanism useful for ensuring collision-free operation. Each station (STA) uses its physical carrier sense to detect transmissions from other STAs. However, in certain situations, it may not be possible for a STA to detect every transmission. For instance, when one STA is located far away from another STA, it might perceive the medium as idle and start transmitting a frame, leading to collisions. To mitigate this hidden node problem, the network allocation vector (NAV) has been introduced.

As the IEEE 802.11 standard continues to evolve, it now includes scenarios where multiple users can simultaneously transmit or receive data within a basic service set (BSS), such as uplink (UL) and downlink (DL) multi-user (MU) transmissions in a cascaded manner. In these cases, the existing carrier sense and NAV mechanisms may not be sufficient, and modifications or newly defined mechanisms may be required to facilitate efficient and collision-free operation.

For the purpose of this disclosure, MU transmission refers to situations where multiple frames are transmitted to or from multiple STAs simultaneously using different resources. Examples of these resources include different frequency resources in Orthogonal Frequency Division Multiple Access (OFDMA) transmission and different spatial streams in Multi-User Multiple Input Multiple Output (MU-MIMO) transmission. Consequently, downlink OFDMA (DL-OFDMA), downlink MU-MIMO (DL-MU-MIMO), uplink OFDMA (UL-OFDMA), uplink MU-MIMO (UL-MU-MIMO), and OFDMA with MU-MIMO are all considered examples of MU transmission.

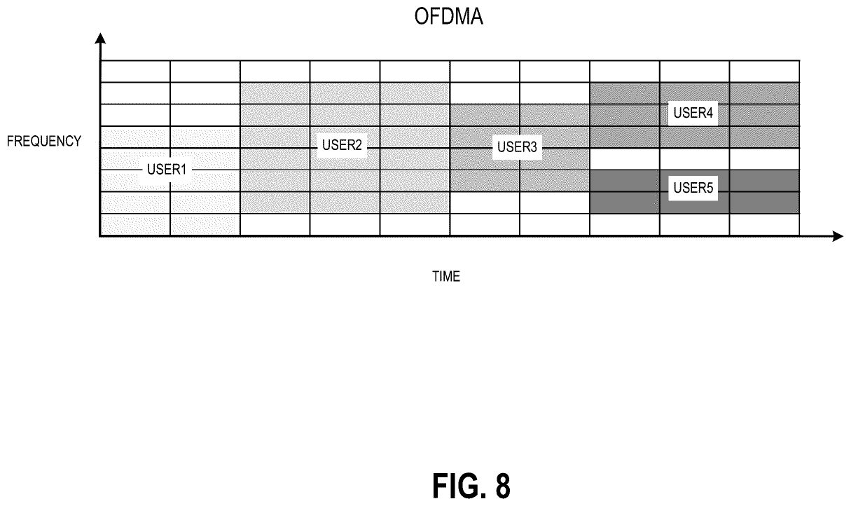

FIG. 8 illustrates an example of multi-user (MU) transmission in Orthogonal Frequency-Division Multiple Access (OFDMA), in accordance with some embodiments of the present disclosure.

In the IEEE 802.11ax and 802.11be specifications, the trigger frame plays a useful role in facilitating uplink multi-user (MU) transmissions. The purpose of the trigger frame is to allocate resources and solicit one or more Trigger-based (TB) Physical Layer Protocol Data Unit (PPDU) transmissions from the associated stations (STAs).

The trigger frame contains information required by the responding STAs to send their Uplink TB PPDUs. This information includes the Trigger type, which specifies the type of TB PPDU expected, and the Uplink Length (UL Length), which indicates the duration of the uplink transmission.

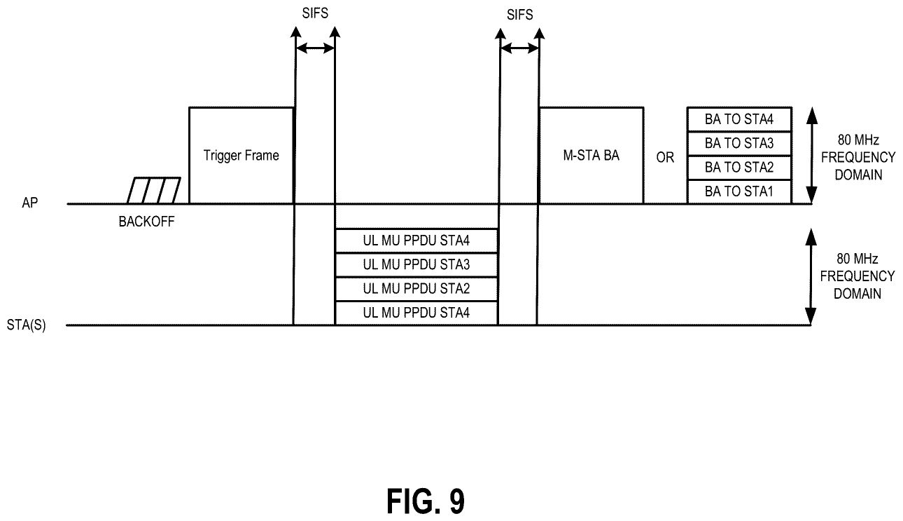

FIG. 9 illustrates an example scenario where an access point (AP) operating in an 80 MHz bandwidth environment sends a Trigger frame to multiple associated STAs. Upon receiving the Trigger frame, the STAs respond by sending their respective Uplink Orthogonal Frequency Division Multiple Access (UL OFDMA) TB PPDUs, utilizing the allocated resources within the specified 80 MHz bandwidth.

After successfully receiving the UL OFDMA TB PPDUs, the AP acknowledges the STAs by sending an acknowledgement frame. This acknowledgement can be in the form of an 80 MHz width multi-STA Block Acknowledgement (Block Ack) or a Block Acknowledgement with a Direct Feedback (DF) OFDMA method. The multi-STA Block Ack allows the AP to acknowledge multiple STAs simultaneously, while the Block Ack with DF OFDMA enables the AP to provide feedback to the STAs using the same OFDMA technique employed in the uplink transmission.

The trigger frame is a useful component in enabling efficient uplink MU transmissions in IEEE 802.11ax and 802.11be networks, by allocating resources and coordinating the uplink transmissions from multiple STAs within the same bandwidth.

Wireless network systems can rely on retransmission of media access control (MAC) protocol data units (MPDUs) when the transmitter (TX) does not receive an acknowledgement from the receiver (RX) or MPDUs are not successfully decoded by the receiver. Using an automatic repeat request (ARQ) approach, the receiver discards the last failed MPDU before receiving the newly retransmitted MPDU. With requirements of enhanced reliability and reduced latency, the wireless network system can evolve toward a hybrid ARQ (HARQ) approach.

There are two methods of HARQ processing. In a first type of HARQ scheme, also referred to as chase combining (CC) HARQ (CC-HARQ) scheme, signals to be retransmitted are the same as the signals that previously failed because all subpackets to be retransmitted use the same puncturing pattern. The puncturing is needed to remove some of the parity bits after encoding using an error-correction code. The reason why the same puncturing pattern is used with CC-HARQ is to generate a coded data sequence with forward error correction (FEC) and to make the receiver use a maximum-ratio combining (MRC) to combine the received, retransmitted bits with the same bits from the previous transmission. For example, information sequences are transmitted in packets with a fixed length. At a receiver, error correction and detection are carried out over the whole packet. However, the ARQ scheme may be inefficient in the presence of burst errors. To solve this more efficiently, subpackets are used. In subpacket transmissions, only those subpackets that include errors need to be retransmitted.

Since the receiver uses both the current and the previously received subpackets for decoding data, the error probability in decoding decreases as the number of used subpackets increases. The decoding process passes a cyclic redundancy check (CRC) and ends when the entire packet is decoded without error or the maximum number of subpackets is reached. In particular, this scheme operates on a stop-and-wait protocol such that if the receiver can decode the packet, it sends an acknowledgement (ACK) to the transmitter. When the transmitter receives an ACK successfully, it terminates the HARQ transmission of the packet. If the receiver cannot decode the packet, it sends a negative acknowledgement (NAK) to the transmitter and the transmitter performs the retransmission process.

In a second type of HARQ scheme, also referred to as an incremental redundancy (IR) HARQ (IR-HARQ) scheme, different puncturing patterns are used for each subpacket such that the signal changes for each retransmitted subpacket in comparison to the originally transmitted subpacket. IR-HARQ alternatively uses two puncturing patterns for odd numbered and even numbered transmissions, respectively. The redundancy scheme of IR-HARQ improves the log likelihood ratio (LLR) of parity bit(s) in order to combine information sent across different transmissions due to requests and lowers the code rate as the additional subpacket is used. This results in a lower error rate of the subpacket in comparison to CC-HARQ. The puncturing pattern used in IR-HARQ is indicated by a subpacket identity (SPID) indication. The SPID of the first subpacket may always be set to 0 and all the systematic bits and the punctured parity bits are transmitted in the first subpacket. Self-decoding is possible when the receiving signal-to-noise ratio (SNR) environment is good (i.e., a high SNR). In some embodiments, subpackets with corresponding SPIDs to be transmitted are in increasing order of SPID but can be exchanged/switched except for the first SPID.

AP coordination has been considered as a potential technology to improve WLAN system throughput in the IEEE 802.11be standard and is still being discussed in the IEEE 802.11bn (UHR) standard. To support various AP coordination schemes, such as coordinated beamforming, OFDMA, TDMA, spatial reuse, and joint transmission, a predefined mechanism for APs is necessary.

In the context of coordinated TDMA (C-TDMA), the AP that obtains a transmit opportunity (TXOP) is referred to as the sharing AP. This AP initiates the AP coordination schemes to determine the AP candidate set by sending a frame, such as a Beacon frame or probe response frame, which includes information about the AP coordination scheme capabilities. The AP that participates in the AP coordination schemes after receiving the frame from the sharing AP is called the shared AP. The sharing AP is also known as the master AP or coordinating AP, while the shared AP is referred to as the slave AP or coordinated AP.

The operation of various AP coordination schemes has been discussed in the IEEE 802.11be and UHR standards:

Coordinated Beamforming (C-BF): Multiple APs transmit on the same frequency resource by coordinating and forming spatial nulls, allowing for simultaneous transmission from multiple APs.

Coordinated OFDMA (C-OFDMA): APs transmit on orthogonal frequency resources by coordinating and splitting the spectrum, enabling more efficient spectrum utilization.

Joint Transmission (JTX): Multiple APs transmit jointly to a given user simultaneously by sharing data between the APs.

Coordinated Spatial Reuse (C-SR): Multiple APs or STAs adjust their transmit power to reduce interference between APs.

By implementing these AP coordination schemes, WLAN systems can improve their overall throughput and efficiency by leveraging the cooperation between multiple APs.

Improving rate-vs-range performance is expected to be an important consideration for future generations of wireless networks. Some of the candidate technologies for improving the rate-vs-range performance include relay operations, finer modulation coding scheme (MCS) grid, long range PHY mode, MIMO/TXBF (multiple input multiple output and transmit beamforming) enhancement, and multi-AP operations.

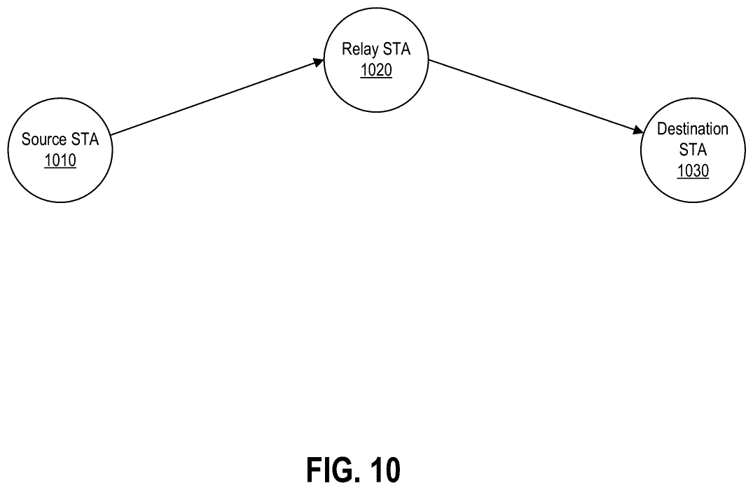

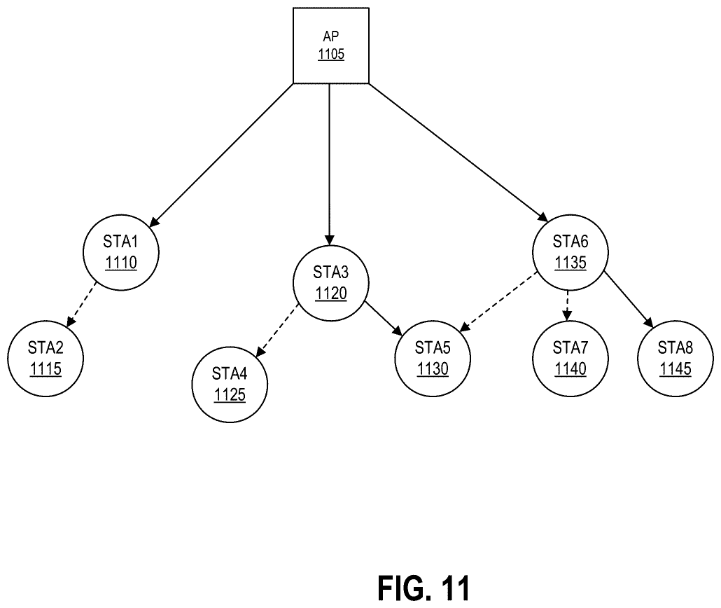

Relay operations are expected to be used in next generation wireless networks (e.g., wireless networks that are to implement the beyond IEEE 802.11be or IEEE 802.11bn wireless networking standard) to expand communication coverage area and improve end-to-end throughout. Relay operations may be used for station-to-station communications (e.g., as shown in FIG. 10) and/or for AP-to-station communications (e.g., as shown in FIG. 11).

FIG. 10 is a diagram showing a network configuration in which relay operations may be used for station-to-station communications, according to some embodiments.

As shown in the diagram, the network configuration includes a source STA 1010, a relay STA 1020, and a destination STA 1030. The source STA 1010 may transmit data intended for the destination STA 1030 to the relay STA 1020. The relay STA 1020 may then relay the data intended for the destination STA 1030 to the destination STA 1030. In this way, the relay STA 1020 may act as a relay between the source STA 1010 and the destination STA 1030.

FIG. 11 is a diagram showing a network configuration in which relay operations may be used for multiple AP-to-station communications, according to some embodiments.

As shown in the diagram, the network configuration includes an AP 1105 and multiple STAs including STA1 1110, STA2 1115, STA3 1120, STA4 1125, STA5 1130, STA6 1135, STA7 1140, STA7 1140, and STA8 1145. The arrows shown in the diagram with solid lines represent links over which communications are occurring and the arrows shown in the diagram with dashed lines represent links over which no communications are occurring. In the example shown in the diagram, the AP 1105 may transmit data intended for STA5 1130 to STA3 1120. STA3 1120 may then relay the data intended for STA5 1130 to STA 5 1130. In this way, STA3 1120 may act as a relay between the AP 1105 and STA5 1130. STA3 1120 may also potentially act as a relay between the AP 1105 and STA4 1125. Similarly, the AP 1105 may transmit data intended for STA8 1145 to STA6 1135. STA6 1135 may then relay the data intended for STA8 1145 to STA8 1145. In this way, STA6 1135 may act as a relay between the AP 1105 and STA8 1145. STA6 1135 may also potentially act as a relay between the AP 1105 and STA5 1130 and/or STA7 1140. Also, STA1 1110 may potentially act as a relay between the AP 1105 and STA2 1115.

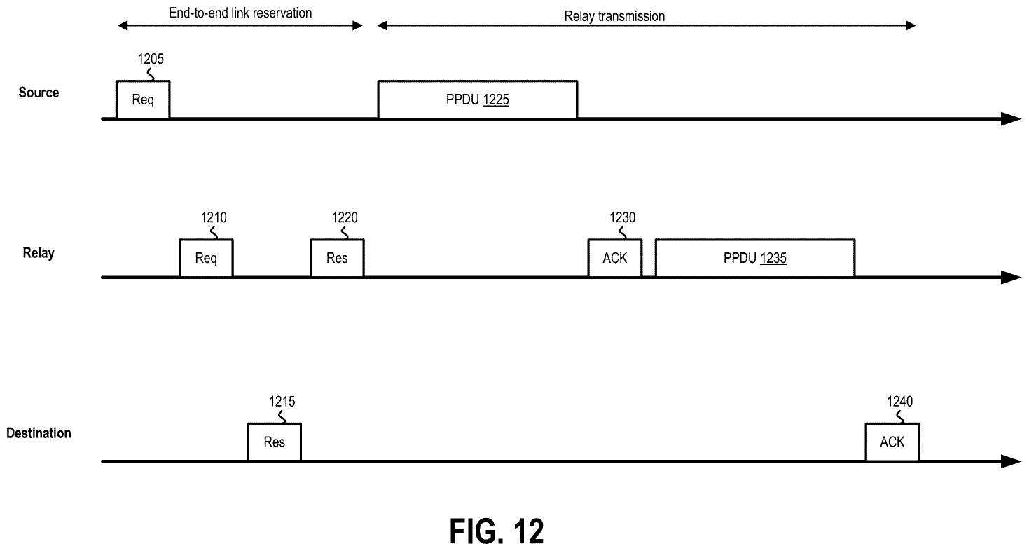

FIG. 12 is a diagram showing relay operations with a non-STR MLD relay STA, according to some embodiments.

One of the objectives of next generation wireless networks (e.g., wireless networks that are to implement the beyond IEEE 802.11be or IEEE 802.11bn wireless networking standard) is to reduce transmission latency. However, a challenge with relay operations is that end-to-end channel reservation is required and that processing at the relay STA can increase latency.

For example, as shown in the diagram, the source STA may transmit request frame 1205 to the relay STA and the relay STA may relay request frame 1205 to the destination STA by transmitting relay request frame 1210 to the destination STA. Responsive to receiving relay request frame 1210, the destination STA may transmit response frame 1215 to the relay STA and the relay STA may relay response frame 1215 to the source STA by transmitting relay response frame 1220 to the source STA. The exchange of the request frame and response frame may be used to reserve an end-to-end link for a relay transmission.

Once the end-to-end link has been reserved, the source STA may transmit PPDU 1225 to the relay STA and the relay STA may acknowledge the contents of PPDU 1225 by transmitting ACK frame 1230 to the source STA. The relay STA may then relay PPDU 1225 to the destination STA by transmitting relay PPDU 1235 to the destination STA. As used herein, a relay PPDU may be a PPDU that is transmitted for relaying purposes. A relay PPDU may have the same or similar contents/payload as original PPDU that is being relayed. The destination STA may acknowledge the contents of relay PPDU 1235 by transmitting ACK frame 1240 to the relay STA.

As mentioned above, one of the objectives of next generation wireless networks is to reduce latency. In next generation wireless networks, it is contemplated that non-AP STAs may act as relays and may support muti-link operations (e.g., they may be STR MLDs). In such case, the latency of relay operations can be reduced by leveraging multi-link capabilities. For example, if the relay STA is a STR MLD, the relay STA may relay a PPDU to a destination STA in one channel while at the same time transmitting an ACK frame to the source STA in another channel to acknowledge the contents of the PPDU received from the source STA, thereby reducing latency. In next generation wireless networks, it will be desirable for the time and space complexity of relay operations to be as small as possible.

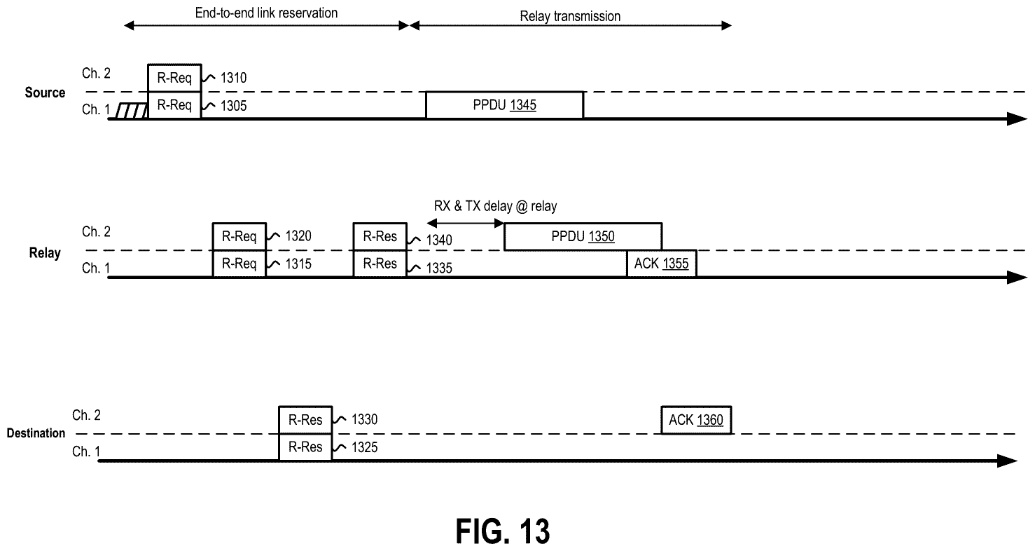

FIG. 13 is a diagram showing relay operations with a STR MLD relay STA, according to some embodiments.

As shown in the diagram, the source STA may simultaneously transmit relay request frame (R-req) 1305 and relay request frame 1310 to the relay STA in a first channel (“Ch. 1”) and a second channel (“Ch. 2”), respectively. The relay STA may simultaneously relay these relay request frames received from the source STA to the destination STA by transmitting relay request frame 1315 and relay request frame 1320 to the destination STA in the first channel and the second channel, respectively. Responsive to receiving the relayed relay request frames from the relay STA, the destination STA may simultaneously transmit relay response frame (R-Res) 1325 and relay response frame 1330 to the relay STA in the first channel and second channel, respectively. The relay STA may relay these relay response frames received from the destination STA to the source STA by simultaneously transmitting relay response frame 1335 and relay response frame 1340 to the source STA in the first channel and the second channel, respectively. The exchange of relay request frames and relay response frames may be used to reserve end-to-end links (one link on the first channel and another link on the second channel) for relay transmission. The exchange of relay request frames and relay response frames may be used for exchanging various information between the source STA, relay STA, and/or destination STA before the relay transmission begins such as explicit/implicit mode information and relay transmission method information (e.g., multi-link index (e.g., indicating which links to use), ACK policy (e.g., normal ACK, no ACK, block ACK, etc.), early stop, etc.).

Once the end-to-end links have been reserved, the source STA may transmit PPDU 1345 to the relay STA in the first channel and the relay STA may relay PPDU 1345 to the destination STA by transmitting relay PPDU 1350 to the destination STA in the second channel. The relay STA may transmit relay PPDU 1350 following a receive (RX) and transmit (TX) delay after beginning the reception of PPDU 1345 from the source STA. As shown in the diagram, the relay STA's transmission of relay PPDU 1350 may partially overlap with the relay STA's reception of PPDU 1345 (which reduces latency compared to a serial (non-overlapping) transmission approach).

Upon successfully receiving PPDU 1345 from the source STA, the relay STA may transmit ACK frame 1355 to the source STA in the first channel that acknowledges the contents of PPDU 1345. As shown in the diagram, the relay STA's transmission of ACK frame 1355 may partially overlap with the relay STA's transmission of relay PPDU 1350. Also, upon successfully receiving relay PPDU 1350 from the relay STA, the destination STA may transmit ACK frame 1360 to the relay STA in the second channel that acknowledges the contents of relay PPDU 1350. As shown in the diagram, the relay STA's reception of ACK frame 1360 may partially overlap with the relay STA's transmission of ACK frame 1355.

A relay STA may relay a PPDU using an amplify-and-forward (AF) relay transmission technique or a decode-and-forward (DF) relay transmission technique. With the AF relay transmission technique, the relay STA may forward the received signal from the source STA by shifting the channel (e.g., using a different link) and amplifying the signal, without decoding the received signal. With the DF relay transmission technique, the relay STA may decode the signal received from the source STA, re-encode the contents of the received signal, and then transmit the re-encoded signal to the destination STA in a different channel.

Accordingly, as shown in the diagram, if the relay STA is a STR MLD, the relay STA may immediately start relaying a PPDU received from the source STA (after a RX and TX delay) without having to wait until it receives the complete PPDU from the source STA, thereby reducing relay transmission latency.

Although such relay operations can reduce relay transmission latency, by relaying immediately without checking whether there were any errors in receiving the PPDU at the relay STA, the retransmission process may become inefficient. For example, the source STA may have to wait for an ACK timeout to occur after finishing transmission of the PPDU to the relay STA before being able to determine that an error might have occurred in the relay STA receiving the PPDU, which delays the retransmission.

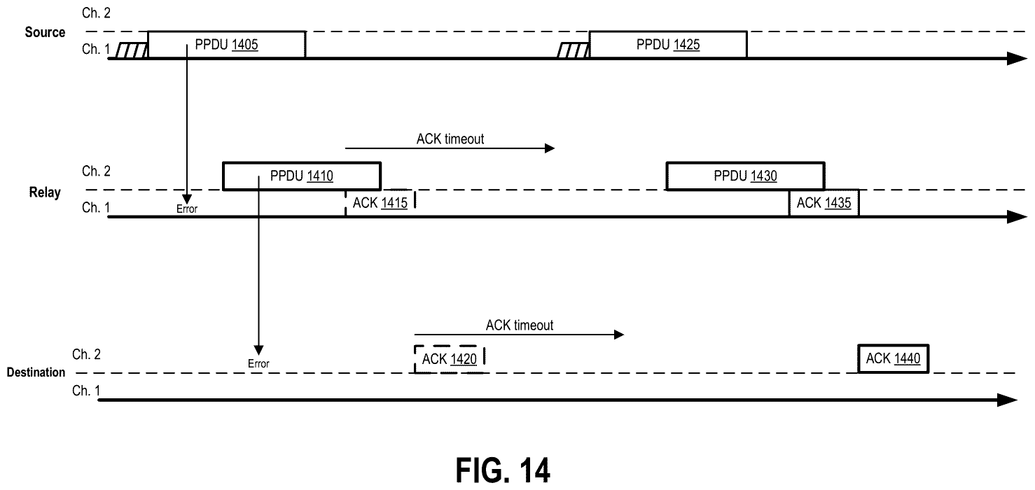

FIG. 14 is a diagram showing an example of inefficient retransmission when an error situation occurs, according to some embodiments.

For sake of simplicity, the example shown in this diagram and some of the other diagrams focus on the relay transmissions after the appropriate link(s) have already been reserved.

As shown in the diagram, the source STA may transmit PPDU 1405 to the relay STA in the first channel but there may be an error in the relay STA receiving PPDU 1405. The relay STA may still relay PPDU 1405 to the destination STA by transmitting relay PPDU 1410 to the destination STA. As a result, there may also be an error in the destination STA receiving relay PPDU 1410. Due to the error in receiving PPDU 1405, the relay STA may not transmit ACK frame 1415 to the source STA (as depicted in the diagram by ACK frame 1415 being in dashed lines). Also, due to the error in receiving relay PPDU 1410, the destination STA may not transmit ACK frame 1420 to the relay STA (as depicted in the diagram by ACK frame 1420 being in dashed lines). The source STA may only retransmit PPDU 1405 to the relay STA after waiting for an ACK timeout (without receiving an ACK frame from the relay STA) to occur. For example, the source STA may retransmit PPDU 1405 by transmitting PPDU 1425 to the relay STA after the ACK timeout occurs. The relay STA may then relay PPDU 1425 to the relay STA by transmitting relay PPDU 1430 to the destination STA. Upon successfully receiving PPDU 1425 from the source STA, the relay STA may transmit ACK frame 1435 to the source STA in the first channel. Also, upon successfully receiving relay PPDU 1430 from the relay STA, the destination STA may transmit ACK frame 1440 to the relay STA in the second channel.

In this example situation, the source STA does not recognize the error situation until after an ACK timeout occurs. Thus, the source STA does not retransmit PPDU 1405 until after the ACK timeout occurs, which is inefficient (e.g., it adds unnecessary latency).

Embodiments are disclosed herein that can reduce latency of relay transmissions with STR MLDs. Embodiments may allow the source STA to more quickly detect when an error situation has occurred at the relay STA and retransmit the data without having to wait for an ACK timeout to occur.

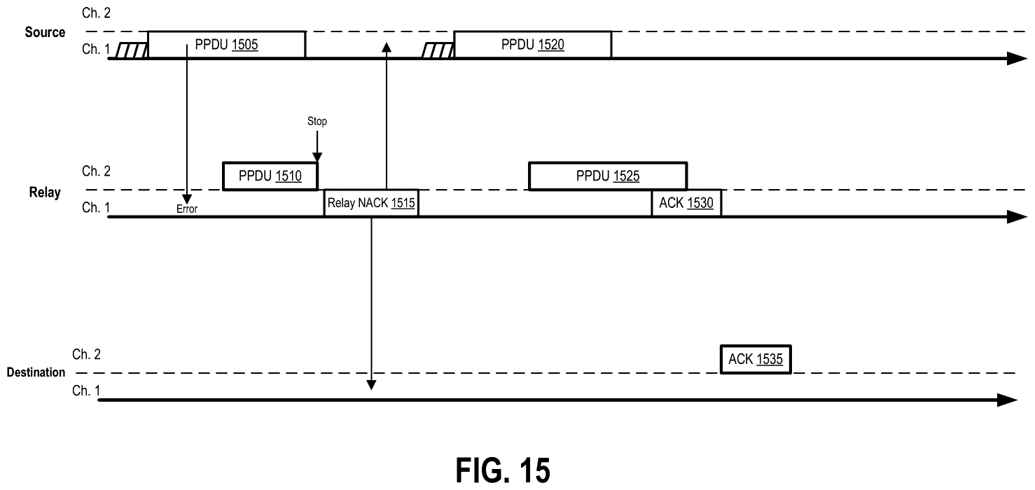

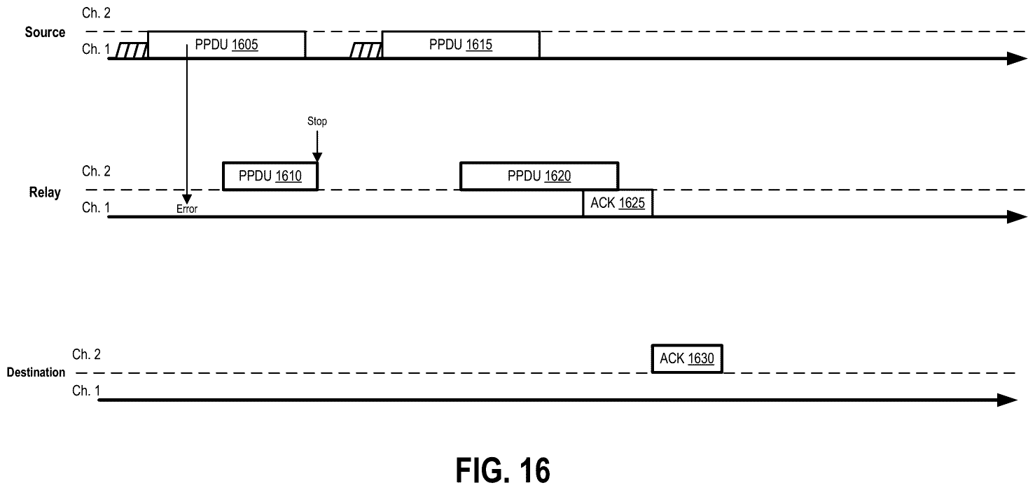

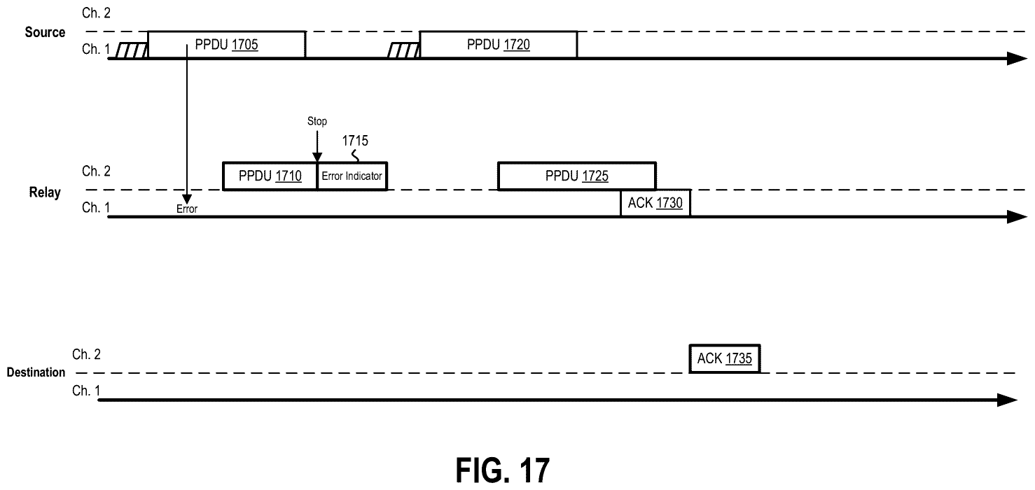

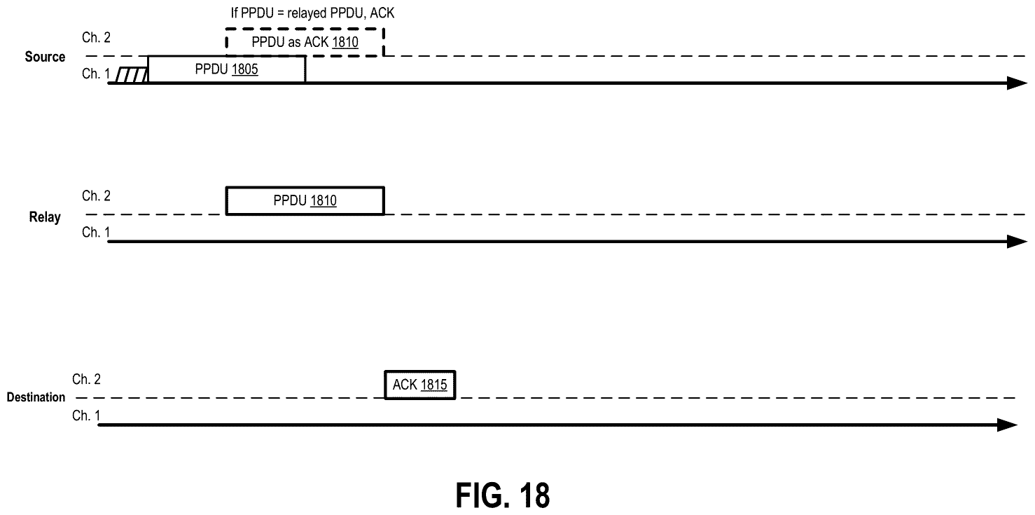

Four different approaches for the source STA to determine that an error occurred in the relay STA receiving the PPDU are described herein. The first approach is shown in FIG. 15, the second approach is shown in FIG. 16, the third approach is shown in FIG. 17, and the fourth approach is shown in FIG. 18, each of which is described in further detail herein below.

### Approach #1: Detect Relay NACK Frame

FIG. 15 is a diagram showing a first approach for determining that an error occurred in the relay STA receiving the PPDU, according to some embodiments.

As shown in the diagram, the source STA may transmit PPDU 1505 that is intended for the destination STA to the relay STA in the first channel. The relay STA may relay PPDU 1505 to the destination STA by transmitting relay PPDU 1510 to the destination STA in the second channel. In this example, the relay STA detects an error in receiving PPDU 1505 and ends the transmission of relay PPDU 1510 early. The relay STA may then transmit relay NACK frame 1515 to the source STA and the destination STA in the first channel. Relay NACK frame 1515 may indicate that the relaying was unsuccessful. The source STA may determine that an error occurred in the relay STA receiving PPDU 1505 based on receiving relay NACK frame 1515 without having to wait for an ACK timeout to occur. Responsive to determining that an error occurred in the relay STA receiving PPDU 1505, the source STA may retransmit PPDU 1505 by transmitting PPDU 1520 (which may have the same contents as PPDU 1505) in the first channel. Relay STA may relay PPDU 1520 to the destination STA by transmitting relay PPDU 1525 to the destination STA in the second channel. Upon successfully receiving PPDU 1520 from the source STA, the relay STA may transmit ACK frame 1530 to the source STA in the first channel that acknowledges the contents of PPDU 1520. Also, upon successfully receiving relay PPDU 1525 from the relay STA, the destination STA may transmit ACK frame 1535 to the relay STA in the second channel that acknowledges the contents of relay PPDU 1525. Although the example shown in the diagram shows the relay NACK frame being transmitted in a single channel (channel 1), in some embodiments, the relay NACK frame can be transmitted in multiple channels (e.g., using a plurality of links). This allows the delivery of the relay NACK frame to be more resistant to errors and noise, and thereby avoid having to be retransmitted, which may result in increased latency.

Approach 2: Detect that Relaying Ended Early

FIG. 16 is a diagram showing a second approach for determining that an error occurred in the relay STA receiving the PPDU, according to some embodiments.

As shown in the diagram, the source STA may transmit PPDU 1605 that is intended for the destination STA to the relay STA in the first channel. The relay STA may relay PPDU 1605 to the destination STA by transmitting relay PPDU 1610 to the destination STA in the second channel. In this example, the relay STA detects an error in receiving PPDU 1605 and ends the transmission of relay PPDU 1610 early. The source STA may determine that an error occurred in the relay STA receiving PPDU 1605 based on detecting that the relay STA ended relaying of relay PPDU 1610 early. The source STA may detect that the relay STA ended relaying of relay PPDU 1610 early based on checking the transmission time/duration of relay PPDU 1610 in the second channel (i.e., how long relay PPDU 1610 has been transmitted for). The source STA need not be a STR MLD to perform this check (e.g., the relay STA may be a non-STR MLD). Since the source STA knows the transmission duration of the PPDUs, it may only need to check that the transmission of relay PPDU 1610 is maintained for the expected duration, without having to decode relay PPDU 1610 itself. Responsive to determining that an error occurred in the relay STA receiving PPDU 1605, the source STA may retransmit PPDU 1605 by transmitting PPDU 1615 (which may have the same contents as PPDU 1605) in the first channel without having to wait for an ACK timeout to occur. Relay STA may relay PPDU 1615 to the destination STA by transmitting relay PPDU 1620 to the destination STA in the second channel. Upon successfully receiving PPDU 1615 from the source STA, the relay STA may transmit ACK frame 1625 to the source STA in the first channel that acknowledges the contents of PPDU 1615. Also, upon successfully receiving relay PPDU 1620 from the relay STA, the destination STA may transmit ACK frame 1630 to the relay STA in the second channel that acknowledges the contents of relay PPDU 1620.

### Approach #3: Detect Error Indicator

FIG. 17 is a diagram showing a third approach for determining that an error occurred in the relay STA receiving the PPDU, according to some embodiments.

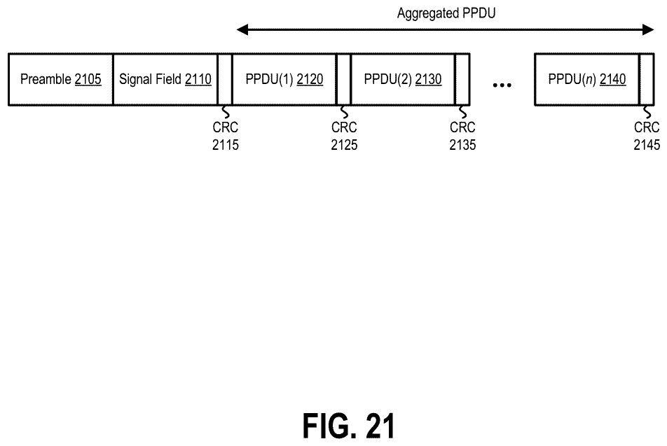

As shown in the diagram, the source STA may transmit PPDU 1705 that is intended for the destination STA to the relay STA in the first channel. The relay STA may relay PPDU 1705 to the destination STA by transmitting relay PPDU 1710 to the destination STA in the second channel. In this example, the relay STA detects an error in receiving PPDU 1705 and ends the transmission of relay PPDU 1710 early. The relay STA may then transmit an error indication 1715 (e.g., negative acknowledgement (NACK) signature indicating the link index of the link in which the PPDU error occurred and PPDU error information (if the PPDU is aggregated, it can also include information regarding how many sub-PPDUs had an error)) in the second channel after ending the transmission of relay PPDU 1710 early (e.g., the error indication 1715 may be added to the end of relay PPDU 1710 (e.g., padding in OFDM PPDU symbol units)). If PPDU 1705 is an A-PPDU, the relay STA may determine that an error occurred in receiving PPDU 1705 based on performing a CRC of a signal field included in PPDU 1705 or based on performing a CRC of a sub-PPDU included in PPDU 1705 (e.g., if the relay STA is using a DF relay transmission technique). An example A-PPDU format that enables such operation is shown in FIG. 21 and described with reference thereto. The relay STA may end transmission of relay PPDU 1710 early if it determines that an error occurred in receiving PPDU 1705 from the source STA. The source STA may determine that an error occurred in the relay STA receiving PPDU 1705 based on receiving the error indication 1715 in the second channel. Responsive to determining that an error occurred in the relay STA receiving PPDU 1705, the source STA may retransmit PPDU 1705 by transmitting PPDU 1720 (which may have the same contents as PPDU 1705) in the first channel without having to wait for an ACK timeout to occur. Relay STA may relay PPDU 1720 to the destination STA by transmitting relay PPDU 1725 to the destination STA in the second channel. Upon successfully receiving PPDU 1720 from the source STA, the relay STA may transmit ACK frame 1730 to the source STA in the first channel that acknowledges the contents of PPDU 1720. Also, upon successfully receiving relay PPDU 1725 from the relay STA, the destination STA may transmit ACK frame 1735 to the relay STA in the second channel that acknowledges the contents of relay PPDU 1725.

While the second approach may be considered to be an implicit error detection approach, the third approach may be considered to be an explicit error detection approach (since the relay STA provides an explicit notification to the source STA regarding the error situation).

### Approach #4: Integrity Check

FIG. 18 is a diagram showing a fourth approach for determining that an error occurred in the relay STA receiving the PPDU, according to some embodiments.

As shown in the diagram, the source STA may transmit PPDU 1805 that is intended for the destination STA to the relay STA in the first channel. The relay STA may relay PPDU 1805 to the destination STA by transmitting relay PPDU 1810 to the destination STA in the second channel. The source STA may determine whether relay PPDU 1810 transmitted by the relay STA is the same as PPDU 1805 that the source STA transmitted to the relay STA. If the two PPDUs are the same, then the source STA may determine that the relay transmission was successful. Otherwise, if the two PPDUs are different, the source STA may determine that an error occurred in the relay STA receiving PPDU 1805. When using an AF relay transmission technique, the PPDU transmitted by the source STA and the relay PPDU transmitted by the relay STA should be the same if no error occurs. When using a DF relay transmission technique, the relay STA may transmit relay PPDU 1810 using the same scramble seed that the source STA used for transmitting PPDU 1805. The source STA may need to be a STR MLD in this case to be able to compare relay PPDU 1810 with the original PPDU 1805. Upon successfully receiving relay PPDU 1810 from the relay STA, the destination STA may transmit ACK frame 1815 to the relay STA in the second channel that acknowledges the contents of relay PPDU 1810. If the source STA determines that an error occurred in the relay STA receiving PPDU 1805, the source STA may retransmit PPDU 1805 in the first channel without having to wait for an ACK timeout to occur.

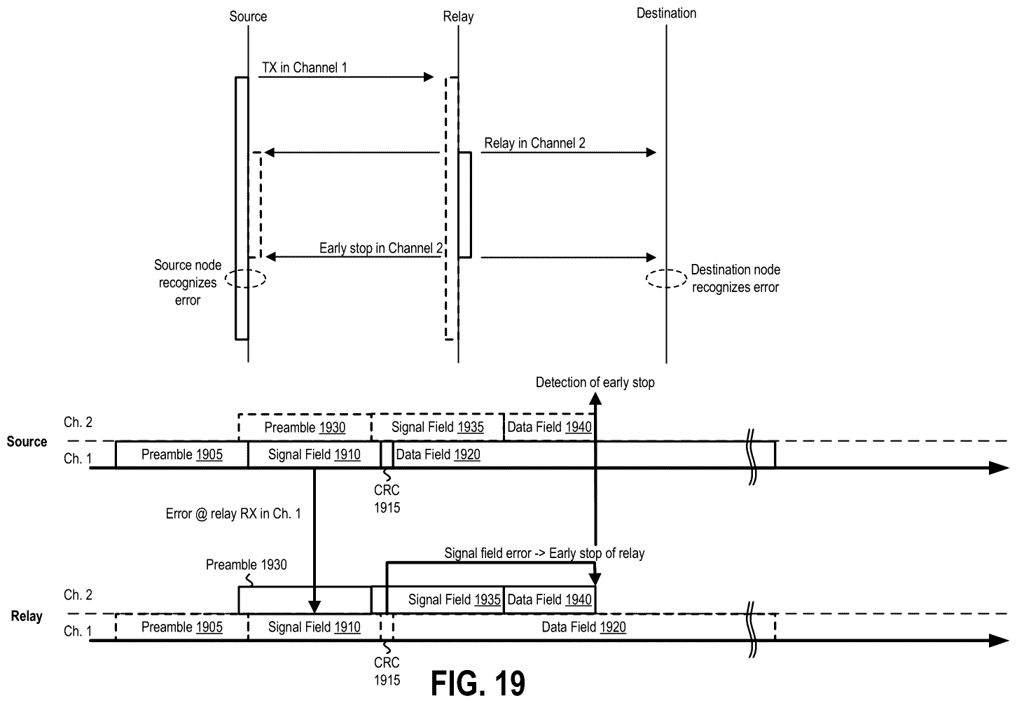

FIG. 19 is a diagram showing an example of a relay STA ending transmission of a relay PPDU early based on detecting a signal field decoding error, according to some embodiments. In the diagram, PPDU transmissions are depicted in solid lines and PPDU receptions are depicted in dashed lines.

As shown in the diagram, the source STA may transmit a PPDU to the relay STA in a first channel. The PPDU may include preamble 1905, signal field 1910, CRC field 1915, and data field 1920. The relay STA may relay the PPDU to the destination STA by transmitting a relay PPDU to the destination STA in a second channel. The relay PPDU may include preamble 1930, signal field 1935, and data field 1940. Although not shown in the diagram, the relay PPDU may include a CRC field similar to the original PPDU. The relay STA may relay the PPDU using a DF relay transmission technique. If the relay STA detects a signal field decoding error while receiving and decoding the PPDU from the source STA, the relay STA may end the transmission of the relay PPDU early (e.g., in the middle of transmitting data field 1940). The relay STA may detect the signal field decoding error based on performing a CRC of signal field 1910 using a CRC value included in CRC field 1915. The source STA and the destination STA may recognize the error situation based on detecting that the transmission of the relay PPDU ended earlier than expected. Responsive to recognizing the error situation, the source STA may begin the retransmission process. In this example, the source STA continues transmitting the PPDU in the first channel even after recognizing the error situation.

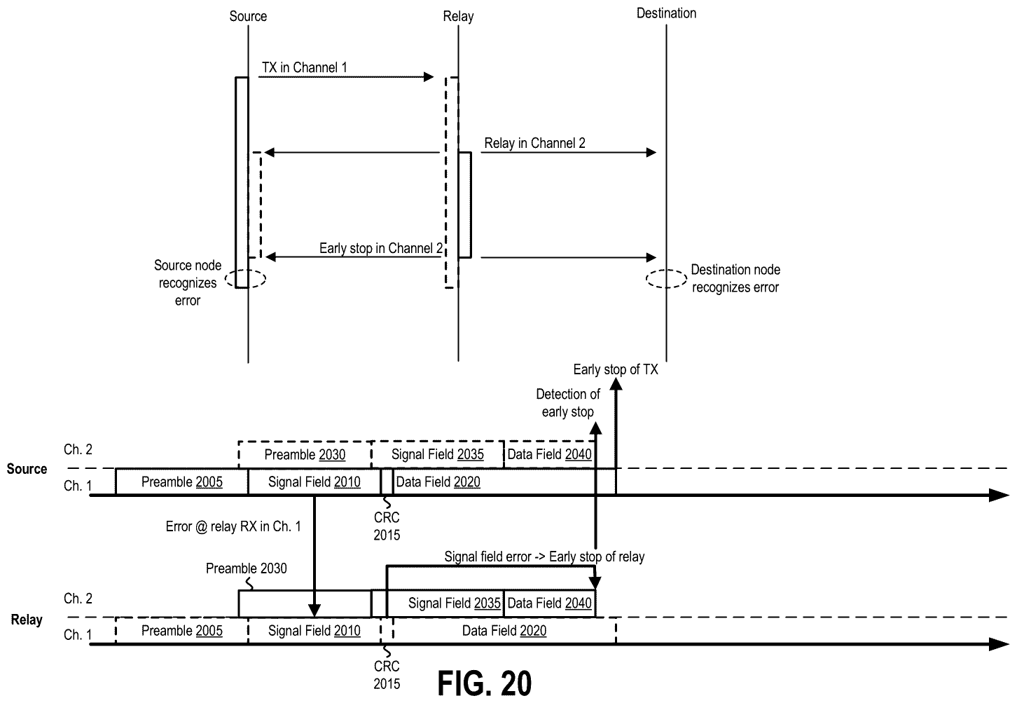

FIG. 20 is a diagram showing an example of a source STA ending transmission of a PPDU early based on detecting that a relay STA ended transmission of a relay PPDU early, according to some embodiments. In the diagram, PPDU transmissions are depicted in solid lines and PPDU receptions are depicted in dashed lines.

As shown in the diagram, the source STA may transmit a PPDU to the relay STA in a first channel. The PPDU may include preamble 2005, signal field 2010, CRC field 2015, and data field 2020. The relay STA may relay the PPDU to the destination STA by transmitting a relay PPDU to the destination STA in a second channel. The relay PPDU may include preamble 2030, signal field 2035, and data field 2040. The relay STA may relay the PPDU using a DF relay transmission technique. If the relay STA detects a signal field decoding error while receiving the PPDU from the source STA, the relay STA may end the transmission of the relay PPDU early (e.g., in the middle of transmitting data field 2040). The relay STA may detect the signal field decoding error based on performing a CRC of signal field 2010 using a CRC value included in CRC field 2015. The source STA and the destination STA may recognize the error situation based on detecting that the transmission of the relay PPDU ended earlier than expected. Responsive to recognizing the error situation, the source STA may begin the retransmission process. In this example, the source STA also ends the transmission of the PPDU in the first channel early upon recognizing the error situation.

FIG. 21 is a diagram showing an example format of an aggregated PPDU, according to some embodiments.

As shown in the diagram, the A-PPDU may include preamble 2105, signal field 2110, CRC field 2115 corresponding to signal field 2110, multiple sub-PPDUs (including sub-PPDU #1 2120, sub-PPDU #2 2130, and sub-PPDU #n 2140), and multiple CRC fields corresponding to the multiple sub-PPDUs (e.g., including CRC field 2125 corresponding to sub-PPDU #1 2120, CRC field 2135 corresponding to sub-PPDU #2 2130, and CRC field 2145 corresponding to sub-PPDU #n 2140). While a particular A-PPDU format is shown in the diagram, it should be appreciated that an A-PPDU may include additional fields, omit some fields, and/or have a different arrangement of fields than what is shown in the diagram. Thus, the A-PPDU format shown in the diagram should be regarded as illustrative rather than restrictive.

A relay STA receiving such an A-PPDU may perform a CRC of signal field 2110 using the CRC value included in the corresponding CRC field 2115 to determine whether an error occurred in receiving and decoding signal field 2110. Also, the relay STA may perform a CRC of each sub-PPDU field using the CRC value included in the corresponding CRC field to determine whether an error occurred in receiving and decoding that sub-PPDU. As will be described in additional detail herein below, a relay STA that receives such an A-PPDU may end transmission of a relay A-PPDU early if it detects an error in receiving/decoding a sub-PPDU.

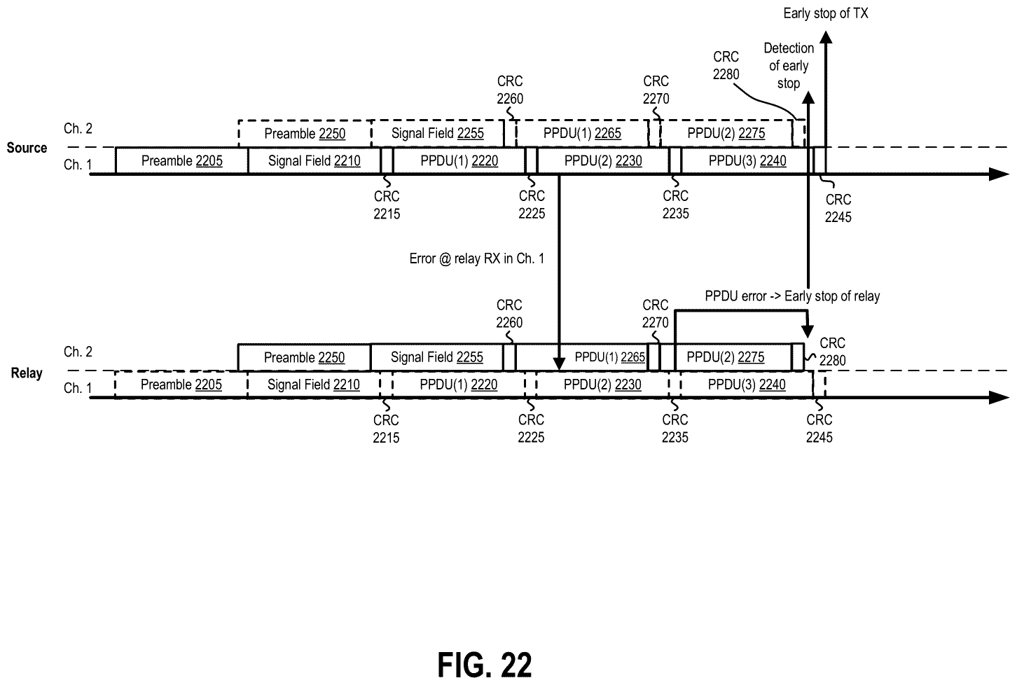

FIG. 22 is a diagram showing an example of a relay STA ending transmission of a relay A-PPDU early based on detecting a sub-PPDU decoding error, according to some embodiments. In the diagram, PPDU transmissions are depicted in solid lines and PPDU receptions are depicted in dashed lines.

As shown in the diagram, the source STA may transmit an A-PPDU to the relay STA in the first channel. The A-PPDU may include preamble 2205, signal field 2210, CRC field 2215, sub-PPDU #1 2220, CRC field 2225, sub-PPDU #2 2230, CRC field 2235, sub-PPDU #3 2240, and CRC field 2245. The relay STA may relay the A-PPDU to the destination STA by transmitting a relay A-PPDU to the destination STA in a second channel. The relay A-PPDU may include preamble 2250, signal field 2255, CRC field 2260, sub-PPDU #1 2265, CRC field 2270, sub-PPDU #2 2275, and CRC field 2280.

The relay STA may perform a CRC of each sub-PPDU using the CRC value included in the corresponding CRC field to determine whether an error occurred in decoding the sub-PPDU. In this example, it is assumed that the relay STA determines that an error occurred in decoding sub-PPDU #2 based on performing a CRC of sub-PPDU #2 2230 using the CRC value included in the corresponding CRC field 2235. Responsive to determining that the error occurred, the relay STA may end transmission of the relay A-PPDU early in the second channel (e.g., before relaying sub-PPDU #3 2240).

The techniques disclosed herein may provide technical advantages. A technical advantage provided by the techniques disclosed herein is that they allow the source STA to quickly detect when an error situation has occurred at the relay STA and retransmit the data without having to wait for an ACK timeout to occur. This may significantly reduce latency of relay transmissions (and particularly retransmissions) with STR-MLDs. Other technical advantages will be apparent to those of ordinary skilled in the art in view of the present disclosure.

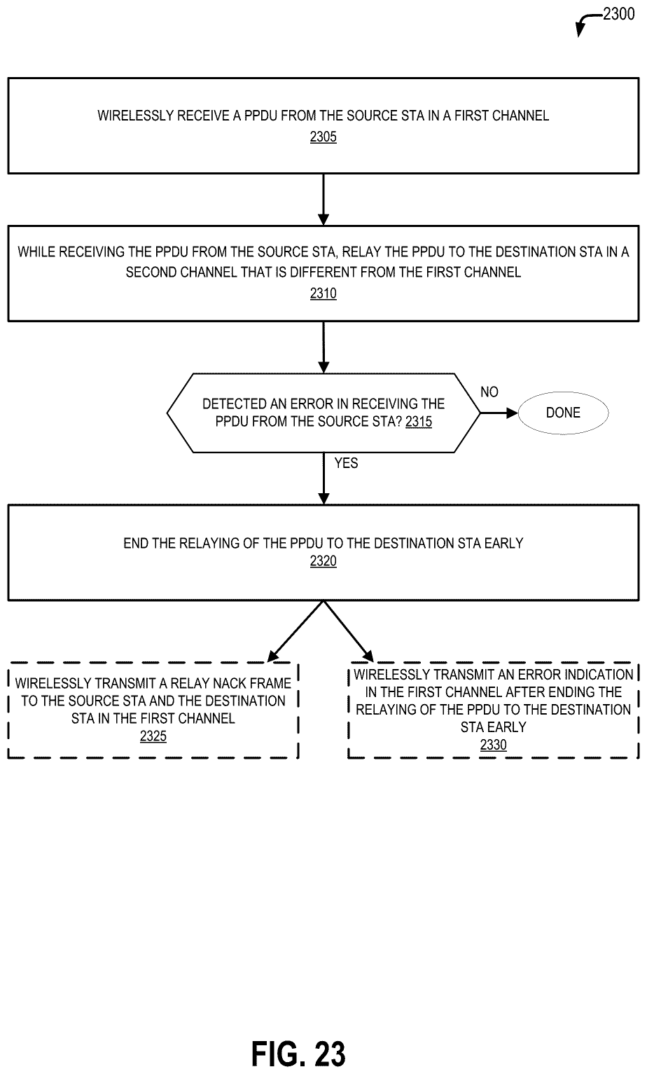

Turning now to FIG. 23, a method 2300 will be described for performing relay operations, in accordance with an example embodiment. The method 2300 may be performed by a relay STA that acts as a relay between a source STA and a destination STA. The relay STA may be implemented by a wireless device (e.g., wireless device 104).

Additionally, although shown in a particular order, in some embodiments the operations of the method 2300 (and the other methods shown in the other figures) may be performed in a different order. For example, although the operations of the method 2300 are shown in a sequential order, some of the operations may be performed in partially or entirely overlapping time periods.

At operation 2305, the relay STA wirelessly receives a PPDU from a source STA in a first channel.

At operation 2310, while receiving the PPDU from the source STA, the relay STA relays the PPDU to the destination STA in a second channel that is different from the first channel. In an embodiment, the PPDU is relayed to the destination STA using an amplify and forward relay transmission technique. In an embodiment, the PPDU is relayed to the destination STA using a decode and forward relay transmission technique.

At operation 2315, the relay STA determines whether it has detected an error in receiving the PPDU from the source STA. In an embodiment, the error in receiving the PPDU from the source STA is detected based on performing a CRC of a signal field included in the PPDU using a CRC value included in a CRC field included in the PPDU. In an embodiment, the PPDU received from the source STA is an A-PPDU that includes a plurality of sub-PPDUs and a plurality of CRC fields each corresponding to one of the plurality of sub-PPDUs, wherein the error in receiving the PPDU from the source STA is detected based on performing a CRC of one of the plurality of sub-PPDU using a CRC value included in one of the plurality of CRC fields corresponding to the sub-PPDU. If there is no error detected in receiving the PPDU from the source STA, the method ends. Otherwise, if the relay STA detected an error in receiving the PPDU from the source STA, the flow moves to operation 2320.

At operation 2320, the relay STA ends the relaying of the PPDU to the destination STA early. In an embodiment, at operation 2325, the relay STA wirelessly transmits a relay NACK frame to the source STA and the destination STA in the first channel. In an embodiment, at operation 2330, the relay STA wirelessly transmits an error indication in the first channel after ending the relaying of the PPDU to the destination STA early.

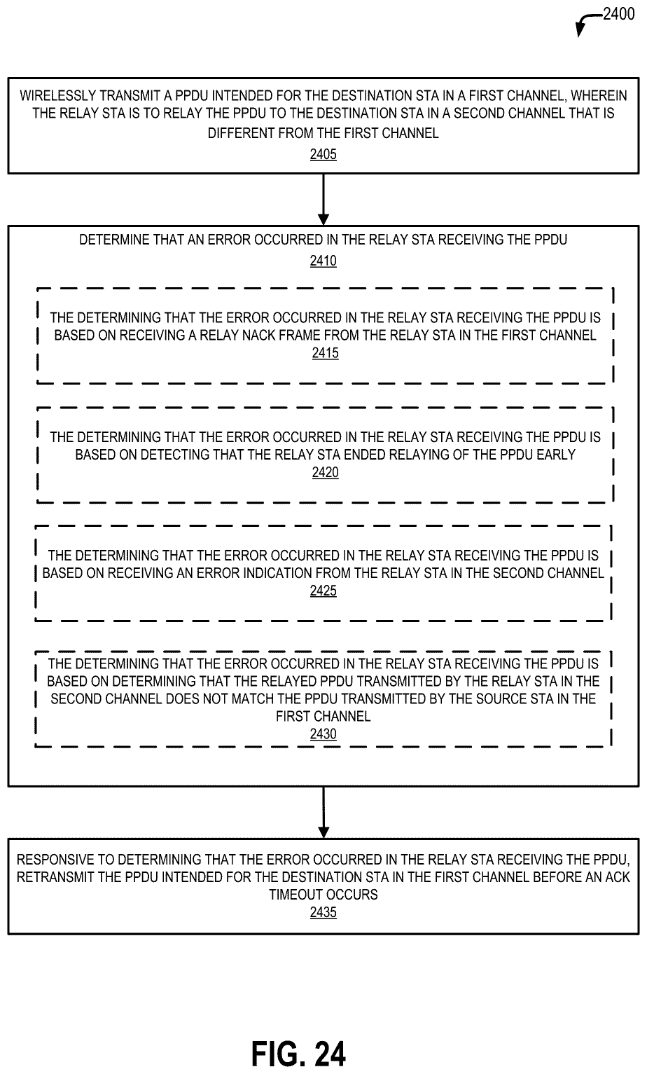

Turning now to FIG. 24, a method 2400 will be described for retransmitting a PPDU with low latency, in accordance with an example embodiment. The method 2400 may be performed by a source STA. The source STA may be implemented by a wireless device (e.g., wireless device 104).

At operation 2405, the source STA wirelessly transmits a PPDU intended for the destination STA in a first channel, wherein the relay STA is to relay the PPDU to the destination STA in a second channel that is different from the first channel. In an embodiment, the PPDU is an A-PPDU that includes a plurality of sub-PPDUs and a plurality of CRC fields each corresponding to one of the plurality of sub-PPDUs.

At operation 2410, the source STA determines that an error occurred in the relay STA receiving the PPDU. In an embodiment, as shown in box 2415, the determining that the error occurred in the relay STA receiving the PPDU is based on receiving a relay NACK frame from the relay STA in the first channel. In an embodiment, as shown in box 2420, the determining that the error occurred in the relay STA receiving the PPDU is based on detecting that the relay STA ended relaying of the PPDU early. In an embodiment, as shown in box 2425, the determining that the error occurred in the relay STA receiving the PPDU is based on receiving an error indication from the relay STA in the second channel. In an embodiment, as shown in box 2430, the determining that the error occurred in the relay STA receiving the PPDU is based on determining that the relayed PPDU transmitted by the relay STA in the second channel does not match the PPDU transmitted by the source STA in the first channel.

At operation 2435, responsive to determining that the error occurred in the relay STA receiving the PPDU, the source STA retransmits the PPDU intended for the destination STA in the first channel before an ACK timeout occurs. In an embodiment, responsive to determining that the error occurred in the relay STA receiving the PPDU, the source STA ends transmission of the PPDU early in the first channel.

Although many of the solutions and techniques provided herein have been described with reference to a WLAN system, it should be understood that these solutions and techniques are also applicable to other network environments, such as cellular telecommunication networks, wired networks, etc. In some embodiments, the solutions and techniques provided herein may be or may be embodied in an article of manufacture in which a non-transitory machine-readable medium (such as microelectronic memory) has stored thereon instructions which program one or more data processing components (generically referred to here as a “processor” or “processing unit”) to perform the operations described herein. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In some cases, an embodiment may be an apparatus (e.g., an AP STA, a non-AP STA, or another network or computing device) that includes one or more hardware and software logic structures for performing one or more of the operations described herein. For example, as described herein, an apparatus may include a memory unit, which stores instructions that may be executed by a hardware processor installed in the apparatus. The apparatus may also include one or more other hardware or software elements, including a network interface, a display device, etc.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system may carry out the computer-implemented methods described herein in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method performed by a relay station (STA) that acts as a relay between a source STA and a destination STA, the method comprising:
wirelessly receiving a physical layer protocol data unit (PPDU) from the source STA in a first channel;
while receiving the PPDU from the source STA in the first channel, relaying the PPDU to the destination STA in a second channel that is different from the first channel; and
responsive to detecting an error in receiving the PPDU from the source STA, ending the relaying of the PPDU to the destination STA early.

2. The method of claim 1, further comprising:
wirelessly transmitting a relay negative acknowledgement (NACK) frame to the source STA and the destination STA in the first channel.

3. The method of claim 1, further comprising:
wirelessly transmitting an error indicator in the second channel after ending the relaying of the PPDU to the destination STA early.

4. The method of claim 1, wherein the PPDU is relayed to the destination STA using an amplify and forward relay transmission technique.

5. The method of claim 1, wherein the PPDU is relayed to the destination STA using a decode and forward relay transmission technique.

6. The method of claim 1, wherein the error in receiving the PPDU from the source STA is detected based on performing a cyclic redundancy check (CRC) of a signal field included in the PPDU using a CRC value included in a CRC field included in the PPDU.

7. The method of claim 1, wherein the PPDU received from the source STA is an aggregated PPDU (A-PPDU) that includes a plurality of sub-PPDUs and a plurality of cyclic redundancy check (CRC) fields each corresponding to one of the plurality of sub-PPDUs, wherein the error in receiving the PPDU from the source STA is detected based on performing a CRC of one of the plurality of sub-PPDU using a CRC value included in one of the plurality of CRC fields corresponding to the sub-PPDU.

8. A method performed by a source station (STA), the method comprising:
wirelessly transmitting a physical layer protocol data unit (PPDU) intended for a destination STA in a first channel, wherein a relay STA is to relay the PPDU to the destination STA in a second channel that is different from the first channel;
determining that an error occurred in the relay STA receiving the PPDU; and
responsive to determining that the error occurred in the relay STA receiving the PPDU, retransmitting the PPDU intended for the destination STA in the first channel before an acknowledgement (ACK) timeout occurs.

9. The method of claim 8, wherein the determining that the error occurred in the relay STA receiving the PPDU is based on receiving a relay negative acknowledgement (NACK) frame from the relay STA in the first channel.

10. The method of claim 8, wherein the determining that the error occurred in the relay STA receiving the PPDU is based on detecting that the relay STA ended relaying of the PPDU early.

11. The method of claim 8, wherein the determining that the error occurred in the relay STA receiving the PPDU is based on receiving an error indication from the relay STA in the second channel.

12. The method of claim 8, wherein the determining that the error occurred in the relay STA receiving the PPDU is based on determining that the relayed PPDU transmitted by the relay STA in the second channel does not match the PPDU transmitted by the source STA in the first channel.

13. The method of claim 8, further comprising:
responsive to determining that the error occurred in the relay STA receiving the PPDU, ending transmission of the PPDU early in the first channel.

14. The method of claim 8, wherein the PPDU is an aggregated PPDU (A-PPDU) that includes a plurality of sub-PPDUs and a plurality of cyclic redundancy check (CRC) fields each corresponding to one of the plurality of sub-PPDUs.

15. A wireless device to implement a relay STA that is to act as a relay between a source STA and a destination STA, the wireless device comprising:
a radio frequency transceiver;
a memory device storing a set of instructions; and
a processor coupled to the memory device, wherein the set of instructions when executed by the processor causes the relay STA to:
wirelessly receive a physical layer protocol data unit (PPDU) from the source STA in a first channel;
while receiving the PPDU from the source STA in the first channel, relay the PPDU to the destination STA in a second channel that is different from the first channel; and
responsive to detecting an error in receiving the PPDU from the source STA, end the relaying of the PPDU to the destination STA early.

16. The wireless device of claim 15, wherein the set of instructions when executed by the processor further causes the relay STA to:
wirelessly transmit a relay negative acknowledgement (NACK) frame to the source STA and the destination STA in the first channel.

17. The wireless device of claim 15, wherein the set of instructions when executed by the processor further causes the relay STA to:
wirelessly transmit an error indicator in the second channel after ending the relaying of the PPDU to the destination STA early.

18. A wireless device to implement a source STA, the wireless device comprising:
a radio frequency transceiver;
a memory device storing a set of instructions; and
a processor coupled to the memory device, wherein the set of instructions when executed by the processor causes the source STA to:
wirelessly transmit a physical layer protocol data unit (PPDU) intended for a destination STA in a first channel, wherein a relay STA is to relay the PPDU to the destination STA in a second channel that is different from the first channel;
determine that an error occurred in the relay STA receiving the PPDU; and
responsive to determining that the error occurred in the relay STA receiving the PPDU, retransmit the PPDU intended for the destination STA in the first channel before an acknowledgement (ACK) timeout occurs.

19. The wireless device of claim 18, wherein the determining that the error occurred in the relay STA receiving the PPDU is based on receiving a relay negative acknowledgement (NACK) frame from the relay STA in the first channel.

20. The wireless device of claim 18, wherein the determining that the error occurred in the relay STA receiving the PPDU is based on detecting that the relay STA ended relaying of the PPDU early.
